(19) United States
(12) Patent Application Publication
(10) Pub. No.: US 2017/0061397 A1
(43) Pub. Date: Mar. 2, 2017

(54) ELECTRONIC COIN SYSTEMS AND METHODS UTILIZING COINS DIGITALLY

(71) Applicant: Chang-Tse Lee, Plano, TX (US)

(72) Inventor: Chang-Tse Lee, Plano, TX (US)

(21) Appl. No.: 14/884,376

(22) Filed: Oct. 15, 2015

Related U.S. Application Data
(60) Provisional application No. 62/210,978, filed on Aug. 27, 2015.

(51) Int. Cl. G06Q 20/06; G06Q 20/02

(52) U.S. Cl. CPC G06Q 20/065; G06Q 20/023

(57) ABSTRACT

An electronic coin system comprising at least one processor that, receives, by the at least one processor, input from a sender device, creates, by the at least one processor, a digital coin check accessible by at least one receiver device responsive to the input from the sender device, stores, in a digital coin payment file in at least one memory, the digital coin check as metadata, wherein the at least one processor and the at least one memory are communicably coupled, notifies, by the at least one processor, the at least one receiver device of the created digital coin check, tracks, by the at least one processor, activity of the digital coin check and allows access, by the at least one processor, to the digital coin check by the at least one receiver device.

### BACKGROUND

The instant disclosure relates generally to processing coins electronically. In particular, the instant disclosure provides for Electronic Coin System (ECS) and Digital Coin Digital Check (DCs) devices and mechanisms to utilize coins checks digitally to provide change payment from a sender to a receiver, and/or from a sender device to a receiver device. In the instant disclosure, sender and sender device will be used interchangeably, additionally, receiver and receiver device will be used interchangeably.

By way of background, the coin system in the United States typically include a dollar coin, half dollar coin, quarter dollar coin, ten cents coin (dime), five cents coin (nickel), and one cent coin (penny). Most circulated in the market are quarter dollar coin, ten cents coin (dime), five cents coin (nickel), and one cent coin (penny). Coins are the widely used way of giving change and accepting payments in businesses like grocery stores and retail establishments. Furthermore, coins are typically exchanged by a cashier or self-operated POS terminal at a self-checkout line.

Traditionally, merchants often transact with consumers face-to-face at points of sale. Such face-to-face transactions typically relate to the buying and selling of goods and/or services between consumers and merchants or other like. In processing face-to-face transactions, giving change is typically limited to coins; merchants and consumers have limited options, which do not take into account convenience and flexibility.

The use of coins in business often has problems associated with risk exposure and time-wasted on driving to banks and making mistake in the giving out wrong change by employees. Furthermore, people often have problems with keeping redundant coins at home and of times drop coins carelessly,

Electronic commerce (E-commerce) is proliferating. The convenience of shopping over the internet has sparked considerable interest in e-commerce on behalf of consumers and merchants. As such, various mechanisms have evolved for electronic payments between business, consumers and the like. Payment systems in the United States fall under one or more payment rails with associated law, regulations, and rules. For example, payments rails include debit cards and Automatic Clearing House (ACH) (regulated under the Electronic Funds Transfer Act (EFTA)), cash transfers (e.g., Western Union, Paypal, etc.), credit cards (regulated under Regulation Z), the checking system (regulated under UCC Articles 3 and 4, Check 21, Regulation CC, and the like), wire transfers (regulated under UCC Article 4A) and the like. In general, these payment rails includes a transfer of monetary value, a transfer instrument(s), evidence of an obligation, devices for transmitting funds, rules regulating disputes, transferability to third parties, rules regulating time of payment, security and the like.

While widely used for online transactions, use of coins in connection with e-commerce presents certain difficulty for online purchases. Thus, under the existing Ecommerce system, the consumer/merchant lacks the option of coinage use as a possible payment option over the internet.

Additionally, coins may have an effect on global warming as the existing coin system prior art does not solve these problems and has not been able to take full advantage of the carbon reduction, potential cost saving and efficiencies of handling coins may be obtained.

### SUMMARY

In one embodiment, an electronic coin system, comprising, at least one processor, wherein the at least one processor performs at least one, receives, by the at least one processor, input from a sender device, creates, by the at least one processor, a digital coin check accessible by at least one receiver device responsive to the input from the sender device, stores, in a digital coin payment file in at least one memory, the digital coin check as metadata, wherein the at least one processor and the at least one memory are communicably coupled, notifies, by the at least one processor, the at least one receiver device of the created digital coin check, tracks, by the at least one processor, activity of the digital coin check and allows access, by the at least one processor, to the digital coin check by the at least one receiver device.

In another embodiment, an electronic coin payment method, comprising at least one of, receiving, by at least one processor, from a sender device a payment to at least one receiver device, creating, by the at least one processor, a digital coin check, responsive to the sender device storing, in at least one memory, the digital coin check as metadata in a digital coin file, wherein the at least one processor and the at least one memory are communicably coupled, notifying, by the at least one processor, the at least one receiver device of the digital coin check, tracking, by the at least one processor, activity of the digital coin check, providing access, by the at least one processor, of the at least one receiver device to the digital coin check and processing the digital coin check by the at least one receiver device.

In a further embodiment, a system, comprising, at least one processor, wherein the at least one processor performs at least one of confirms, by the at least one processor, acceptance of a contract by a first user device, generates, by the at least one processor, a digital coin check as metadata defining a negotiable instrument in an electronic coin payment file, transmits, by the at least one processor, an availability of the digital coin check to a second user device and. processes, by the at least one processor, the electronic coin payment file to provide at least one payment coin to the second user device.

### BRIEF DESCRIPTION OF THE DRAWINGS

The instant disclosure is illustrated and described herein with reference to the various drawings, in which like reference numbers denote like method steps and/or system components, respectively, and in which:

FIG. 1 is a flowchart illustrating the flow of the prior art as coins are processed between a merchant and a consumer;

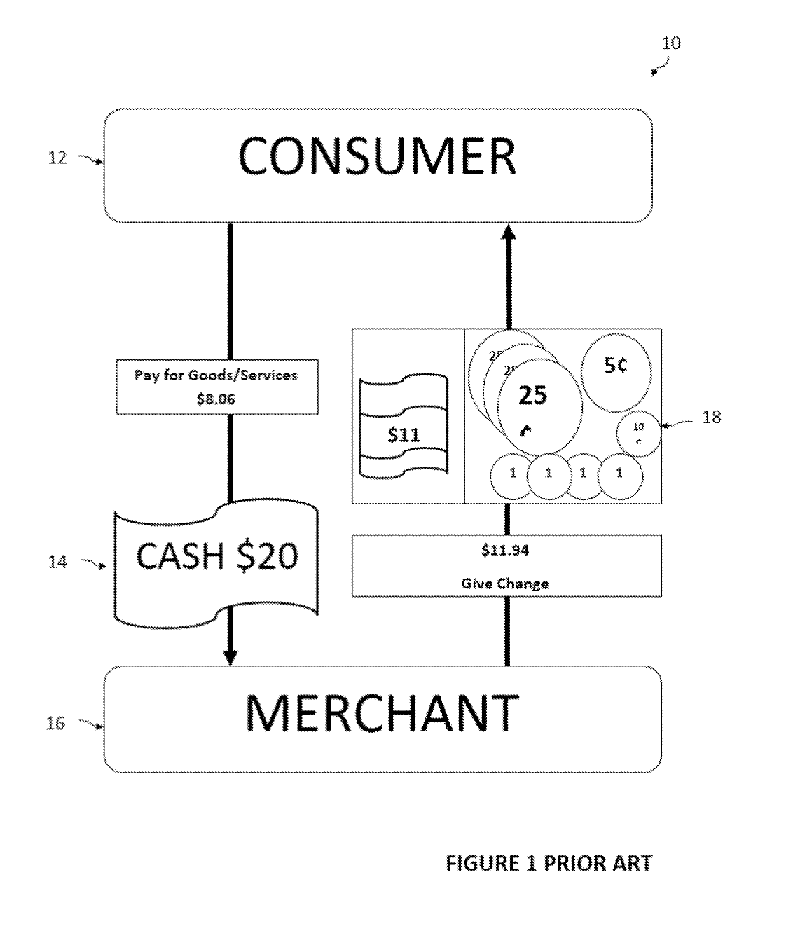

FIG. 2 is a flowchart illustrating the flow of the prior art as coins are processed between a merchant and a consumer;

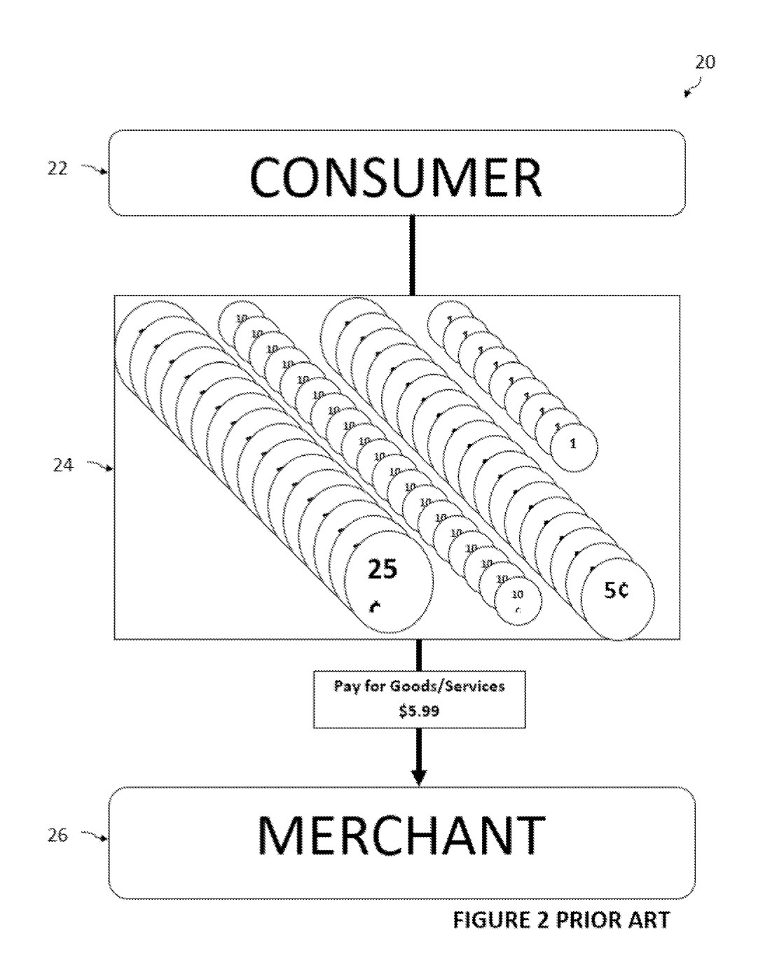

FIG. 3 is a flowchart illustrating the flow of sending coins digitally from a merchant (sender device) to a consumer (receiver device) at a point-of-sale (POS) according to an exemplary embodiment of the instant disclosure;

FIG. 4 is a flowchart illustrating the flow of a consumer/sender purchase goods or services by sending coins stored digitally or drafting a digital check through D2M/D2D according to an exemplary embodiment of the instant disclosure;

FIG. 5 is a block diagram of a digital coin/check file (DCF) according to an exemplary embodiment of the instant disclosure;

FIG. 6 is a block diagram of an ECS system according to an exemplary embodiment of the instant disclosure;

FIG. 7 is a flowchart of a DCs delivery system according to an exemplary embodiment of the instant disclosure, and

FIG. 8 is a flowchart illustrating DCs generation according to an exemplary embodiment of the instant disclosure.

### DETAILED DESCRIPTION

For clarity and simplicity, the present specification shall refer to structural and/or functional network elements, entities and/or facilities, relevant standards, protocols and/or services, and other components that are commonly known in the art without further detailed explanation as to their configuration or operation except to the extent the same has been modified or altered in accordance with and/or to accommodate aspects of the instant disclosure.

In various exemplary embodiment of the instant disclosure, the instant disclosure provides for processing of coins electronically and generating a check digitally between a sender and a receiver by utilizing various devices and technologies such as mobile device, App, Quick Response (OR) code, Near Field Communication (NFC), Radio Frequency ID (RFID), plastic magnetic card, a smart card chip. Bluetooth interface, wearable accessories/devices with built-in-chip, bio-metric recognition, and the like to send or receive coins/check digitally through an electronic coin system (ECS) at a point of sale (POS) through device to machine (D2M) or device to device (D2D). The system includes at least one processor programmed to process coins/checks digitally through an electronic coin system (ECS) which captures sender's metadata instructions regarding the intended digital coins/payment to a receiver. The metadata is stored in a database or the like for further processing instead of exchanging coins and writing checks physically. Advantageously, the ECS provides an E-commerce payment system utilizing Electronic Funds Transfer (ETF) and Automatic Clearing House (ACH) systems. Of note, the instant disclosure allows any user to send stored digital coins/create a digital check utilizing methods provided by the ECS and DCs. Thus, this system provides an anyone-to-anyone, peer to peer (P2P), device to machine (D2M), and device to device (D2D) electronic coin system suitable for use by various Electronic Payments Clearinghouses (EPCH).

In an exemplary embodiment of the instant disclosure, an electronic coin system includes a data store (memory) configured to store a digital coin/payment file, a network interface configured to communicate to a plurality of users, and one or more processors connected to the data store and the network interface. The one or more processors are configured to: send/create digital coin/cheek, store the digital coin/check in the data store, notify a receiver associated with the sent/created digital coin/check, track the digital coin/check and process the digital coin/check; wherein the digital coin/check, is stored as metadata in the digital coin/payment file, and wherein the digital coin/check is sent/created in the stead of a physical coin/check, and wherein the metadata includes the coin instruction, payment instruction, a globally unique identifier, tracking information, and security information, and wherein an output from the metadata in the digital coin/payment file is interoperable with coin/paper and electronic clearing methods associated with Coin/Check 21 clearing systems.

In another exemplary embodiment of the instant disclosure, an electronic coin/payment method includes providing access to an electronic coin/payment system, receiving data associated with coin/payment from a sender to a receiver, sending/creating digital coin/check responsive to the data, wherein the data includes coin/payment instructions, wherein the digital coin/check is stored as metadata in a digital coin/payment file, and wherein the digital coin/check is sent/created in the stead of a physical coin/check, and wherein the metadata includes the coin/payment instruction, a globally unique identifier, tracking information, and security information, notifying the receiver of the digital coin/check, tracking the digital coin/check, processing the digital coin/check responsive to the sender, wherein an output from the metadata is interoperable with coin/paper and electronic clearing methods associated with Coin/Check 21 clearing systems.

In accordance with one aspect of the instant disclosure, the concepts of a system processes coin/check digitally may be widely applied thus allowing more users to receive the benefits. The benefits include faster transaction completion, error elimination from employees, and the reduced risk exposure on driving to banks and on transporting of minting colitis. In addition, the concept may provide more job opportunity, cost saving, tax revenue increasing, felony prevention, global warming responding and boosting the market financially and economically. Finally, if properly implemented, the concepts would enable individuals from consumers to businesses to governments to charities to create and effectively process, secure electronic coin/payment in a manner similar to existing low cost electronic payment methods such as ACH items covered under the National Clearinghouse Association (NACHA) rules.

In various exemplary embodiment of the instant disclosure, systems and methods are provided for an Electronic Payment Clearinghouse EPCH) which operates as an electronic payment system under Check 21 to enable senders and receivers to exchange legal payments. In one embodiment the digital coin check comprises a legal coin check item created and maintained electronically from creation to clearing in the electronic coin system. The EPCH is an online service which allows users/customers to deposit digital check into any bank, such as through a scanned paper check (i.e., an Image Replacement Document (IRD)) and as an electronic file (i.e., an Image and Cash Letter file). The instant disclosure allows for the electronic coin exchanging/electronic check creation and management of cash letter files compliant to American National Standards institute (ANSI) X9.180 or the printing of IRDs compliant to ANSI X9.140 for banks to facilitate user (and bank) by the acceptance of Digital Coin/Digital Check (DCs) and provide faster clearing.

Advantageously, the EPCH understands the DCs record (i.e., security, audit, controls, etc.) so the system may update the digital coin/check record with real time transaction status for individuals involved (i.e., sender, receiver, bank, clearing bank, Fed, etc.). This feature provides small banks with big bank features, and the service may be provided as a co-op that banks join to provide a neutral playing field for DCs exchange (e.g., the EPCH as a private clearinghouse competing with Federal Reserve (Fed) clearing and adding value via the ability to update digital coin file (DCF) records). This feature may also solve the cross-bank security problem where two different banks use two different X.509 PKI security schemes, thus they cannot read one another's encrypted DCs unless the use's bank sent the DCs file to the clearing bank using the EPCH as the middle man via pointing to a Transaction ID. A middle man like EPCH may participate, federate, security models and share a common model in a neutral and secure fashion and facilitate, translate, the security models between banks. Thus faster and better clearing of DCs may happen outside of the existing coins exchange method and a pure Check 21 image file exchange clearing method.

The instant disclosure provides a mechanism to generate and process ACH items and other payment forms and the like, along with digital Coin/Check 21 items. These items may be described as Digital Coin/Digital Check (DCs) processed using the electronic coin system (ECS) which captures sender/receiver metadata which are instructions regarding the intended coins/payment to a consumer/merchant at a point of sale (POS). The metadata is stored in a database or the like for further processing instead of exchanging physical coins/checks. The type of data captured may include traditional information such as instructions for whom to send/pay (receiver name, phone number or email address), some value amount (as a decimal number of some currency), and the coin/payment issue date, the bank account number (traditional checking account number and American Banking Association (ABA) bank routing number), along with some potential set of conditions, limitations, or restrictions, along with memo field description details, and potentially some type of conditional acknowledgements which are defined to be business rules governing how and when the coins/payments are to be sent/made (i.e., putting a contract on the back of a check, thus cashing the check is endorsing the contract).

These coin/payment instructions or metadata may be captured or generated in a variety of ways, methods or devices implemented by the electronic coin system (i.e., an ECS may have multiple input forms). For example, a human user may use a variety of system interface choices including an Internet webpage to input the metadata to generate the digital coin/payment. Alternatively, a telephony device (cell phone, land line, via an IVR call center system, etc.) or an Internet browsing enabled mobile device (PDA/tablet) could be used to login and generate the digital coin/payment. Additionally, the metadata could be generated by a user using a home or office PC software application such as Intuit's Quicken, Microsoft Money, or other accounting software programs. Also, the instant disclosure contemplates the option of having no human user intervention by supporting generation of DCs via an automated software program. This software program could generate pre-scheduled DCs payments with information stored in a coin/payment database to send the resulting DCs files directly into the banking system for payroll or automated accounts payable type business scenarios. The metadata may contain a coin payment instruction, a globally unique identifier, tracking information and security information and the metadata in the digital coin payment file is interoperable with paper and electronic clearing methods associated with check clearing systems.

In order to provide digital Coin/Check 21 items, the instant disclosure utilizes several elements. First, a framework of the Coin/Check 21 law and Coin/Check 21 standards, such as X9.37, 140 and 180, which are herein incorporated by reference in-full, are utilized to enable digital Coin/Check 21 items. Additionally, the payments industry including Item Processing, UCC law, and Electronic Funds Transfer (ETF) law and how the gaps between Check 21 UCC, and Electronic Funds Transfer (EFT) law are filled. Of note, the instant disclosure utilizes a contractual relationship between a receiver and sender to extend Coins/Check 21 warranties throughout the system for DCs. These warranties enable electronic presentment from receivers and senders despite the belief that physical coins/checks are present. §3-501(b) (2) and §4-110 of the Union Commercial Code (U.C.C) specifically authorize banks and other persons to agree to alternative means of presentment, such as electronic coin/image presentment. The instant disclosure leverages these concepts to provide a UCC compliant, secure and Coin/Check 21 compliant item in the form of the DCs.

Additionally, the instant disclosure addresses how graphical user interface (GUI) operating systems, fonts and graphics drivers for video cards, how websites and web services work, how to capture data and store and manage that data as file input into other business processes (ex. Payment clearing-houses). Further, the instant disclosure addresses security concepts: PKI and Certificate Authorities (CAs), cryptography, steganography, SSL, digital signatures using public and private keys, secure hashes and the like. Also, the instant disclosure addresses software design and architectures. Application Programming Interfaces (APIs), programming languages, character set coding (ex. American Standard Code for Information Interchange (ASCII) vs. Extended Binary Coded Decimal Interchange Code (EBCDIC)) in electronic file formats, Unicode, internationalization techniques, and database design including Structured Query Language (SQL) language and the like.

Advantageously, the instant disclosure allows senders and receivers to utilize digital Coin/Check 21 items through the ECS separate and distinct from a metal/paper medium and therefore is applicable to E-commerce for payment. This allows the use of the coin/payment system in place of debit cards, ACH transfers, credit cards, and the like. Further, the instant disclosure offers users the advantages associated with a checking system. The instant disclosure includes mechanisms to enable substitute coins/checks or electronic metadata files to be utilized by users in the stead of physical coins/checks. To open the coin/check payment system to coinless/paperless items include a contractual framework between sender and receiver authorizing the DCs to comply with indemnities and warranties associate with coins/paper checks, security involving PKI for secure digital payments, and computer graphics development to fully comply with standards to ensure full compatibility. The instant disclosure contemplates using the ECS features and mechanisms described herein to process or clear electronic coins/payments utilizing other payment rails in addition to the electronic coin/checking system. For example, the features and mechanisms could be applied to ACH, to wire transfer, Automated Teller Machines (ATM), credit cards, debit cards, etc.

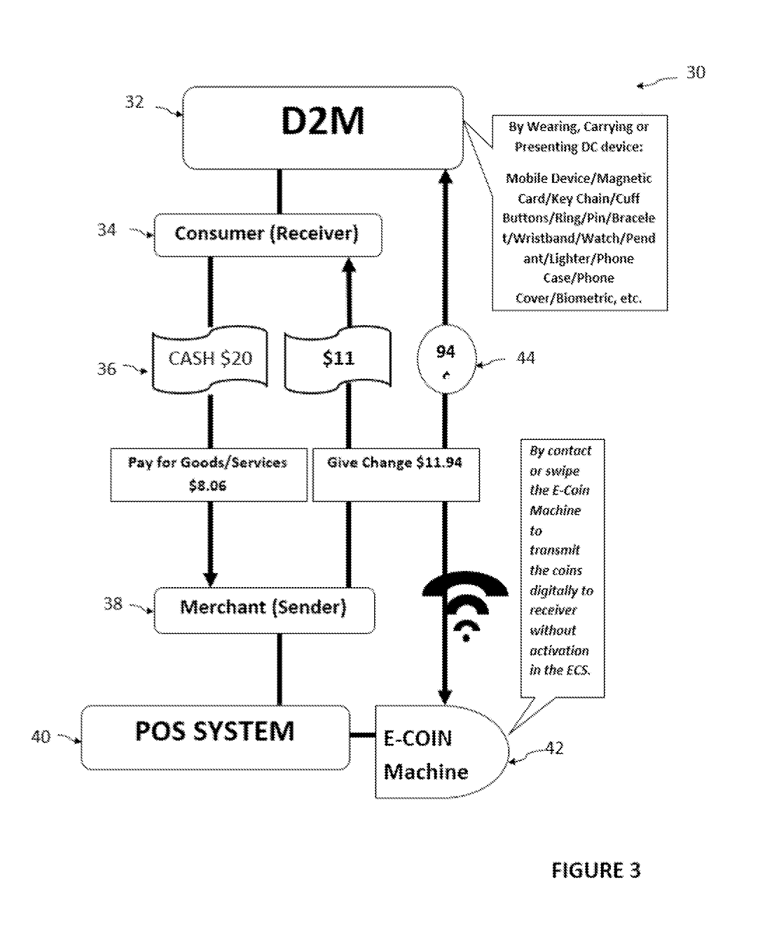

Referring to FIG. 3, in an exemplary embodiment of the instant disclosure, coins are processed electronically from a merchant (sender/sender device) to a consumer (receiver/receiver device) throughout Electronic Coin Machine (ECM) to DC device (D2M) at a Point of Sale (POS) terminal connected to an Electronic Coin System (ECS) 30. DC devices and ECM are operable to send/receive Digital Coin/Digital Check (DCs) items. First, a merchant (sender) activates the account/device(s) in the ECS then setup fund transfer from their Demand Deposit Account (DDA) bank account or deposit funds directly into ECS account to support store's daily transaction activity (giving change) and save time and effort of trips to the bank. Change given out will be automatically deducted from merchant's ECS account and electronically transmitted through an ECM to consumers. A consumer (receiver) may utilize a variety of DC devices/technologies by swiping or contacting the Electronic Coin Machine (ECM) 42 at the checkout to receive change as digital coins from a merchant (sender) in an authenticated state. In addition, a consumer (receiver) may choose the donate option on the ECM to donate their change via ECS to the charity groups.

The DCs device may include a plurality of information transmission mechanisms including, one or two magnetic swipe strips, a Radio Frequency ID (RFID) chip, a smart card chip, a mobile device, QR code, Near Field Communication (NFC), Bluetooth interface, wearable accessories/devices with built-in-chip, bio-metric and the like. The DCs device is configured to transfer the account information (i.e. metadata) into a POS device. The extra strips are add traditional ACH or Debit/Credit card swipe features to a DCs device for backwards compatibility with older POS equipment that cannot read the new device/DCs format. Also, the instant disclosure allows new POS terminals to be developed such as ECM that support DCs processing/generation via the new or alternative contact or contact-less methods. The magnetic stripe is one way to generate the international Standards Organization (ISO) message format data and check account data to process/generate DCs at the point of purchase.

The ECM servers in a manner similar to a credit card machine that support the DCs processing/generation to exchange transactional information and transaction between consumers and merchants. In addition, the ECM may be built and developed to fit into any businesses or machines with widely use of coins such as laundry wash, car wash, vending machines and the like,

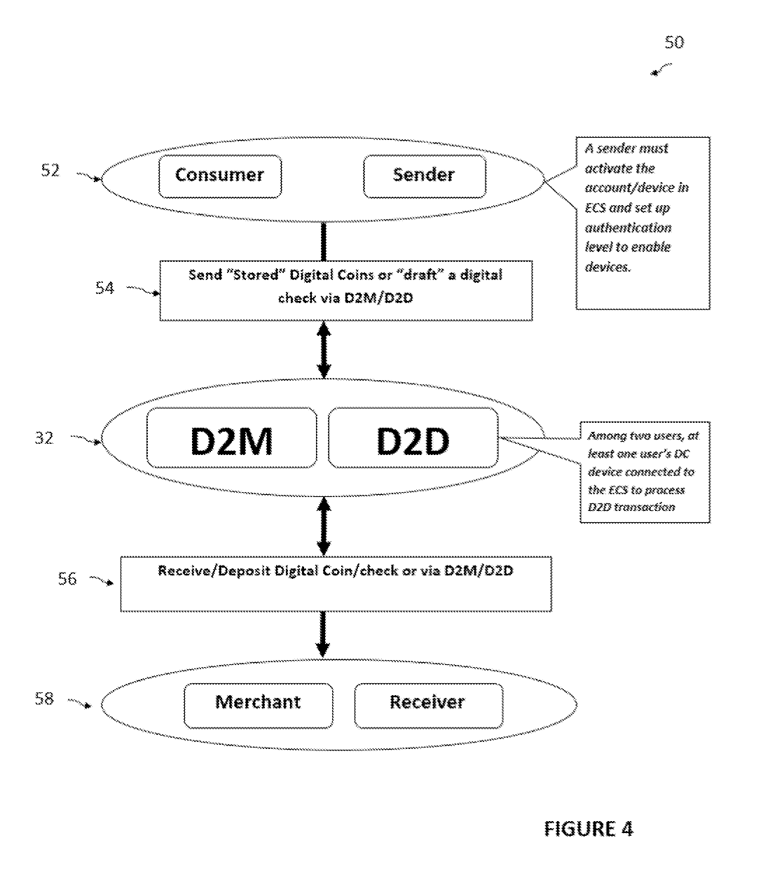

Referring to FIG. 4, in an exemplary embodiment of the instant disclosure, digital coins/digital checks are processed/generated electronically via Device to Machine (D2M)/Device to Device (D2D) connected to an Electronic Coin System (ECS) 50. For example, a sender (consumer) may use the DC device 32 to send stored digital coins or draft a digital check to pay a receiver (merchant) through authentication check of the ECS. First, a sender activates the account/devices in the ECS then choose authentication levels to enable sending stored digital coins or draft a digital check through D2M/D2D. A sender passes an authentication check to send digital coins/digital check. In order to utilize D2D, among two DC users at least one user's DC device connected to the ECS. In addition, the ECS is applicable to E-commerce for payments through authentication checks of the ECS.

The ECS 82 may be configured to store credits on the consumer's 52 account. For example, when purchasing an item using a DC device, the DC is issued to the merchant, this transaction may be easily reversed if the customer returns the item to the store. Thus, by swiping or contacting the ECM the ECS 82 may instantly reverse the DC (or cancel it, or issue store credit)—this is easier than putting a stop payment on the DC or waiting for credit to your account. Alternatively, the Merchant may send a DC back to your account instead of a crediting your account. The ECS 82 has a choice—automatically issue the stop payment on the DC or issue a mirror image reversed DC (from merchant's account back to the customer's account).

Additionally, a sender may use the ECS to ‘draft’ a digital check (DC). A DC is processed electronically throughout an ECS, a banking or EPCH clearing system 80. The DC is created through an ECS, and the DC is a valid UCC draft in electronic form under the Check 21 X9 standards. The DC is created with user initiated instruction to send/pay someone (i.e., a receiver), some value amount, under a set of conditions, limitations, restrictions, acknowledgements, and the like. These digital instructions are stored in a database, e.g. a Digital Coin File (DCF). These digital instructions are used to send digital coins and create a digital check. Thus, digital coins/digital checks may be processed and generated by utilizing D2M at a POS terminal or D2D among any users equipped with. DC devices (either sender or receiver's. DC device connects to the ECS).

Delivery of the DCs to the receiver is electronic (step 32), and the receiver is notified. This notification mechanism may take a variety of forms of messaging from the ECM/ECS such as sound/voice notification, an email message (e.g., with an embedded URL with transaction ID to automate the retrieval of the DC, an embedded file, and the like), a phone call, a pager message, a fax message, an instant Message (IM), or the like. Additionally, the ECS provide the user with a transaction identification known as a Globally Unique identifier (GUID) to respond ECS notification message to retrieve and lookup any specific DCs transaction. The GUM is an identifier used in software applications in order to provide a reference number used, for example, in defining the internal reference for a type of access point in a software application, or for creating keys in a database. In the instant disclosure, the GUID is sufficiently large to avoid object collisions, i.e. duplicate numbers, and it utilizes an algorithm to ensure GUIDs cannot be spoofed.

The ECS may use the GUID) to lookup the DCs transaction and determine how to authenticate the receiver based on the authentication level chosen by the sender when sending the DCs (or setup by the receiver as a condition for retrieving payments from the ECS under a specific name or ID). Authentication levels may include, none (i.e., just knowing the transaction ID or GUM is enough security for the sender), a personal identification number (PIN) number for the DC (e.g., PIN is sent separately by the sender, i.e. a phone call, or if sent via the ECS it is sent separately from the notification message), bio-metric, additional levels of credentials (e.g., account number and login ID into the ECS), private digital security signature key e.g., using a public key cryptography system), or other level of security mechanism agreed to the parties and supported by the ECS.

The GUID may additionally be used to protect sender personal information. Here, the ECS web service keeps the originating customer's personal information away from the service provider they subscribe with (Web.com website or some other merchant). The customer creates an account code (i.e. a GUID) that identifies how to bill them, the customer gives the GUID to the service/merchant and says bill this account via a DC or creating an ACH debit item or other payment form and the like. The merchant does not know the customers real checking account data that they tell the ECS web service or API to bill this GUID X dollars, the intermediary web server does have the personal data, and the billing is automated via creation of the real DCs or ACH message through the GUID web service translation service. This ECS method does the work of an ACH Credit Push type service for banks, merchants, or service providers who don't know how to do originate ACH or other payment form items.

After satisfying the authentication and security tests, the receiver electronically retrieves a Coin/Check 21 image of the payment and verifies that the payment information is correct. After retrieval and verification, the receiver may choose the method of depositing the DCs into ECS account or their bank account (step 90). The instant disclosure provides the receiver with multiple choices for depositing or clearing the payment. For example, the receiver may retrieve a DCF record for the specific DC (using the GUID), and the ECS may generate a DC image (in Check 21 image format, etc.) and display it allowing the receiver to confirm payment, verify the payment amount, review business conditions or payment constraints (TTL etc.), and the like. After reviewing the DC, such as through the ECS, the receiver has a choice in how to proceed with claiming their payment. First, the receiver may deposit the DC in the ECS or have the ECS forward the DC electronically into their bank as an Image Cash Letter (ICL) exchange for deposit, i.e. using X9.180 clearing methods. For example, the forward deposit may use email to send the ICL to a known bank address, such as deposits bankabc.com, where the bank's computer system, utilizing either an ECS supplied hardware appliance device or the ECS web service or API, may automatically remove the attached ICL file in order to process and credit the deposited item. Further, the receiver may choose to physically print the DC as an IRD onto paper using a printer, and physically depositing it at the bank like a traditional paper check, i.e. using X9.140 clearing methods. Also, alternatively, the ECS and or hardware appliance may convert the DCs into another form of payment, such as Automatic Clearing House (ACH) and the like.

The ECS/bank provides the receiver credit for the DCs and clears the DCs through the clearinghouse process. As the DC payment is processed or cleared by the banking system, the individual DC file may subsequently be placed into a bank clearinghouse Cash Letter File (X9.180 standard) bundle along with other coin/check items (i.e., digitally created or paper scanned images) and exchanged electronically with other banks. Currently, most of the traditional clearinghouse or electronic image exchange mechanisms support Check 21 image file exchanges including the Federal Reserve System, View Pointe, SVPco/The New York Clearinghouse and the like. Additionally, X9 type image files are used as the accepted format in many private two party (bank-to-bank.) image exchange agreements. For example, banks, such as Wachovia and Bank of America, may exchange image files directly with one another under private clearing agreements in the X9.37 format. Finally, the DC clears through the clearing bank/ECS and transfers the funds to the bank/ECS, and the clearing bank/ECS use the DC image in the sender's monthly statement.

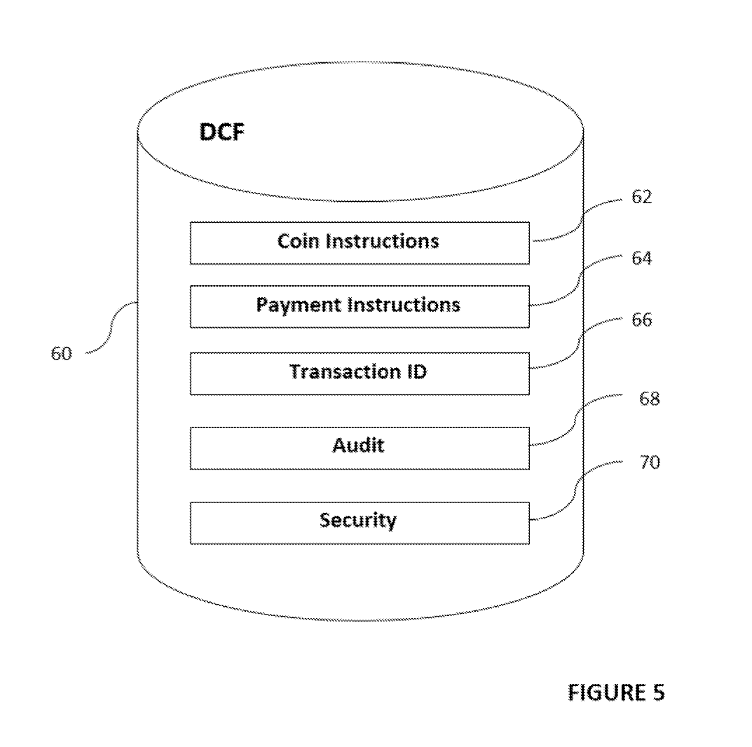

Referring to FIG. 5, a digital coin file (DCF) 60 includes coin instructions 62, payment instructions 64, a transaction identifier 66, audit information 68, and security information 70, according to an exemplary embodiment of the instant disclosure. The DCF 60 represents a digital payment/coin from a sender to a receiver of a Check 21/Coin item. The DCF 60 contains metadata representing a digital coin/check (DCs). The DCF 60 is created, stored, and distributed electronically, such as through an electronic coin system (ECS). For example, an ECS may include a data store (memory), processor, and network interface configured to interact with users, businesses, banks or clearinghouse for creation, distribution, and processing of the DCF 60. The DCF 60 is utilized to provide an electronic coin/check payment that may clear via Check 21 paper or electronic clearing mechanisms.

The coin instructions 62 may include instructions for some value amount (transmit as a decimal number of some currency), the digital coin issue date, whom to send (receiver name, phone number, email address, or the like), the bank account number from which the payment is to be drafted (traditional checking account number and American Bankers Association (ABA) bank routing number), along with some potential set of conditions, limitations, or restrictions, along with memo field description details, and potentially some type of conditional acknowledgements which are defined to be business rules governing how and when the payment are to be made.

The payment instructions 64 may include instructions for whom to pay/send (receiver name, phone number, email address, or the like), some value amount (input/transmit as a decimal number of some currency), the digital coin or payment issue date, the bank account number from which the digital coin or payment is to be drafted (traditional checking account number and American Bankers Association (ABA) bank routing number), along with some potential set of conditions, limitations, or restrictions, along with memo field description details, and potentially some type of conditional acknowledgements which are defined to be business rules governing how and when the payment are to be made (i.e., putting a contract on the back of a check, thus cashing the check is endorsing the contract).

The transaction identifier 66 is a globally unique identifier (GUID) which is a transaction identification used to identify the specific DCF 60 record. The GUI is an identifier used in software applications in order to provide a reference number defining the internal reference for a type of access point in a software application, or for creating keys in a database. In the instant disclosure, the GUID is sufficiently large to avoid object collisions, i.e. duplicate numbers, and it utilizes an algorithm to ensure GUIDs cannot be easily spoofed.

The audit information 68 includes the history for an audit trail of the DCF 60 through the ECS. Since the DCF 80 is an electronic item, it may be tracked real-time. The audit information 88 may include timestamps and associated actions, such as creation, notification of user actions associated with the DCF 60, and the like. For example, the ECS may be configured to track, i.e. record and monitor, interactions with the DCT 60.

The security information 70 includes mechanisms designed to protect the DCF 60 from fraud, counterfeiting, and tampering. The security information 70 may include Public/Private Key infrastructure (PKI) and Certificate Authority (CAs), cryptography, steganography, Secure Socket Link (SSL), digital signatures using public and private keys, secure hashes and the like. Additionally, the security information 70 may include user authentication, such as a Personal Identification Number (PIN) for the DCF 60, additional levels of credentials (e.g., account number and login ID into the ECS), private digital security signature key (e.g., using a public key cryptography system), and the like.

The security information 70 may further include digital security features such as digital watermarks, steganography, and cryptographic features that may be applied to the bitmap sent out to DC recipients. These features apply when the DCF is converted to a paper item, such as substitute coin/check, or an electronic representation of a paper item (e.g., an email with an image of the substitute coin/check). These features may be used to validate that the check was not altered. Some Digital Rights Management (DRM) features could even be Image Survivable meaning that they exist after an Image Replacement Document (IRD) printing and subsequent scanning back into an image (e.g., barcodes).

The security information 70 provided by the ECS may also enable new business services and encourage electronic depositing/processing of DC:s (versus IRD printing/physical coins) because a DC may have a very short life (versus traditional paper checks having a default good for 180 days longer life. For example, the security information 70 may include an ECS settable time-to-live (TTL) metadata value. Here, electronic deposit, such as through the ECS, is preferable in the case of a short TTL. This feature is also useful to a sender to ensure that the DC is accepted by the receiver right away. This allows the sender to confirm that a receiver accepted their offer when it was made with a short lived (e.g., one hour) check/coin. It allows the sender to confirm that they did indeed make a purchase or send a DC (i.e., when an item is offered for sale at an E-commerce auction site and there are multiple parties bidding; the user would tell the ECS to put a short TTL value on their offer using a DC to ensure that the first valid offer in was accepted). This allows the first bidder with the money to be selected because the receiver (i.e., seller) knows that if they wait too long to see what else may come in they could lose the first DC offer they receive. It is envisioned that in one embodiment, accepting by the sender device and the at least one receiver device a full set of warranties and indemnities applicable to banks and clearing banks thereby enabling electronic presentment from the sender device to the at least one receiver device of the digital coin check under a Uniform Commercial Code and extending existing coin check clearing regulations between sender device and the at least one receiver device and through associated banks and clearing banks. It is additionally envisioned that in one embodiment setting of a time-to-live value associated with the digital coin check, wherein upon expiry of the time-to-live value, the digital coin check is no longer valid.

In an exemplary embodiment of the instant disclosure, the DCF 80 represents metadata associated with a digital coin/digital check (DCs) which is compliant to existing Coin/Check 21 paper and electronic clearing methods. These coin/check clearing methods may include a substitute coin/check or Image Replacement Document (IRD) compliant to ANSI X9.37 draft as well as X9.140 IRD final standards, or an image and Cash Letter Format file compliant to X9.180 standards. The coin/check is referred to as a DC due to the computer generation of the DCF 60 to distinguish it from the traditional handling of coins and scanning of a paper check which could be called manual or paper origination of a check image.

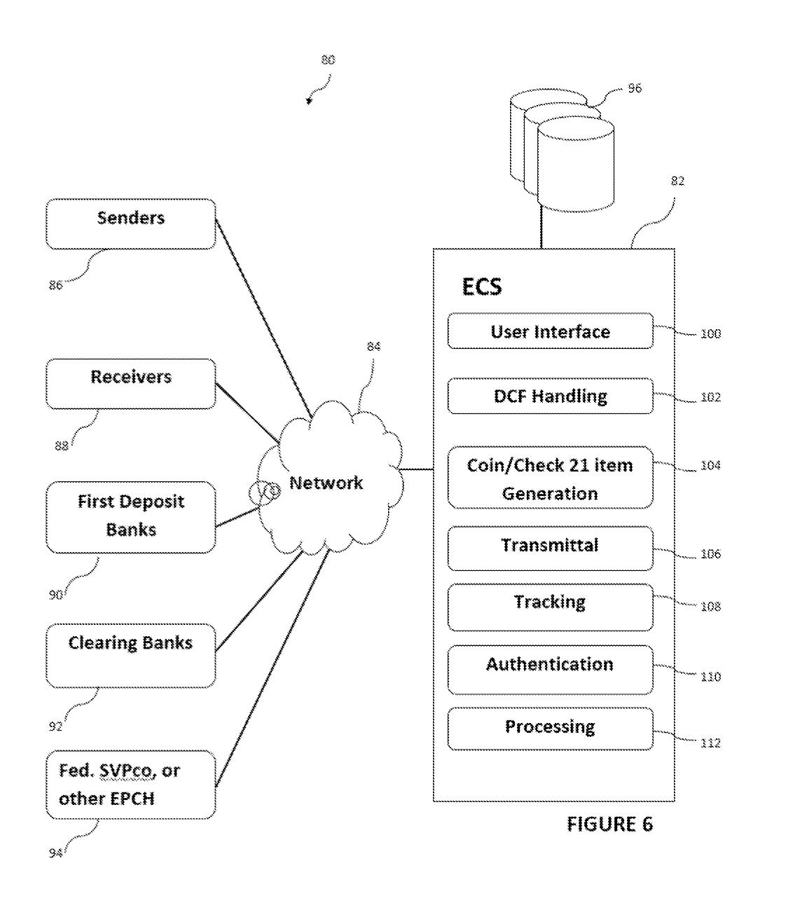

Referring to FIG. 6, an ECS system 80 is illustrated according to an exemplary embodiment of the instant disclosure. As describe herein, an ECS 80 is an electronic system configured to interact with plurality of DC users (i.e. senders and receivers), banks, and other financial institution to enable DCF generation, distribution, tracking, authentication, security, clearing, and the like. The ECS 80 is configured to communicate over a network 84 to a plurality of sender 86, receiver 88, first deposit banks 90, clearing banks 92, clearinghouses 94, and the like,

Generally, the ECS 82 is a computer system which may include multiple processing elements, distributed memory, network interfaces, external data storage 96, and the like. The ECS 82 is configured with processing and data storage redundancy, and is configured communicate to the plurality of senders 86, receivers 88, first deposit banks 90, clearing banks 92, and clearinghouses 94, and the like. The ECS 82 includes various modules, such as a User Interface (UI) 100, DCF handling 102, Coin/Check 21 item generation 104, transmittal module 106, tracking module 108, authentication module 110, and processing module 112. The UI 100 provides a mechanism for users 86, 88, 90, 92, 94 to create, verify, distribute and process DCF files. Further, the UI 100 may provide mechanisms for tracking, modification, clearing, processing, security, authentication, depositing, reissuing, and the like with regards to DCFs. Also, the ECS 82 may include mechanisms for automating these processes in the absence of direct UI 100 access, such as with automated processing.

The DCF handling 102 module is configured to create, modify, update, etc. of DCF files associated with specific digital coins/checks. As described herein, the DCF is a database record storing the metadata instructions related to a digital coin/check. The ECS 82 is configured to store multiple DCFs in the data storage 96 or the like, and to enable the plurality of senders 86, receivers 88, first deposit banks 90, clearing banks 92 and clearinghouses 94 to create, transmit, receive, and process the DCFs. The DCF handling 102 module is configured to create metadata responsive to user input, through automated processing, through various coin/payment truncation methods or scanned check OCR. Also, the DCF handling 102 module manages tracking features, audit features, and the like described further herein.

The Coin/Check 21 item generation 104 module is configured to create Coin/Check 21 images with enhanced quality such that they pass various bank image quality tests such as the stringent Federal Reserve Image Quality Assessment (IQA) tests (see e.g., Black and White Image Standard and Quality Checks document incorporated fully by reference herein) or the X9 guidelines (see e.g., TR-33-2006 Check Image Quality Assurance Standards and Processes document incorporated fully by reference herein). The IQA procedures are a series of tests that are performed on a Coin/Check 21 image file before they will accepted and processed by the Federal Reserve clearing network. The Fed IQA tests are also utilized by a variety of banks as their own internal set of Coin/Check 21 images tests, thus ensuring image file interoperability between any two banks. While DCF may be transmitted electronically as an X9.180 cash letter file, it may also be used to generate the X9.140 standard substitute coin/check or IRD which results in a paper version of the original digital coin/check. The IRD may be printed by the receiver and taken into their bank for deposit because it contains a full set of warranties and indemnities are based on a contract agreed to by the sender and receiver which the ECS 82 are to be signed in order for the DCF to send or receive. Because DCFs are covered under this contract, they have a full set warranties and indemnities that are acceptable to first deposit banks 90 and downstream clearing banks. This novel DCF feature, possessing a full warranty state, differs from other attempts by either businesses or individual consumer users who want to print their own IRD documents and deposit them at a bank because those documents will not be accepted by the first deposit banks 90 due to the depositing bank's inability to take on un-transferable risk from an unknown originator of the IRD. This scenario is contemplated where an individual or business does not have an existing two-party private warranty contract with their which is a concept allowed for under existing UCC law. Also, under the Check 21 regulation as it exists today banks may truncate checks by image them and later extend their warranties to subsequent clearing banks in either electronic or IRD form. It is envisioned that in one embodiment the digital coin check is processed through one of forwarding the metadata to bank as an electronic Cash Letter File, printing a substitute check from the metadata, forwarding the metadata as another digital coin check to a third party, and one of converting and truncating the digital coin check to an Automated Clearing House item.

The transmittal module 106 is configured to handle transaction of DCFs between the various sender 86, receiver 88, first deposit banks 90, clearing banks 92 and clearinghouses 94. As described herein, the DCF includes a GUID as a transaction ID. With the instant disclosure, a bank teller could input into the ECS 66 through UI 100 (e.g., a webpage, web service, API or phone Interactive Voice Response (IVR) system) the digits from the globally unique transaction identifier (GUID) which may be found on the IRD. This GUID input system is linked to the ECS 82 that originally generated the DCF, and which allowed the receiver to print the IRD in the first place. The GUID value may be printed and found on the front of the IRD in the Coin/Check 21 optional data field location where it was placed during the IRD generation process by the Coin/Check 21 item generation module 104.

Using the transmittal module 106, a business service provided by the ECS allows the bank teller at the first deposit banks 90 to request that the specific Coin/Check 21 item be re-generated as an electronic image file and be sent back into the first deposit banks 90 for further processing by their hem Processing department. To accomplish this regeneration, the ECS 82 may use the teller supplied GUID value to look up and retrieve the specific metadata information that was stored in the DCF system. As these re-creation requests arrive at the DCF, the original metadata values (or the currently stored values) are retrieved from the ECS 82 and used to re-create the digital coin/check file in X9 format for further image exchange processing. This electronic X9 file may then be sent or routed directly back to the first deposit banks 90 via a secure electronic link such a Virtual Private Network (VPN) connection, a private clearinghouse (EPCH) secure connection or via the existing Federal Reserve System using the Cash Letter File format. The ability to re-generate at will (or at any future time) a fully compatible Coin/Check 21 digital image instead of handling coins or scanning a paper IRD is a further element of the instant disclosure. The benefits of this feature are derived from the fact that the auto regeneration process using DCF stored metadata avoids the errors of coin miscounting or paper scanning and is a great benefit to banks in reducing the amount of labor involved in handling of coins and paper items. Thus, there is no need to handle coins and scan an IRD submitted for deposit in order to generate the front and back check image in Check 21 format. The regenerated image and data values may be generated directly from the ECS 82 and sent back to the first deposit banks 90 in a Cash Letter File for further image exchange processing.

The tracking module 108 is configured to provide real-time and historical tracking of the DCF created and processed through the ECS 82. The instant disclosure allows the DCF to be generated through the ECS 82 anytime with a full history and audit trail. This is because the DCF is electronic and interactions with the ECS 82 may be recorded, monitored, and tracked through the tracking module 108. Additionally, the DCF may be processed locally on paper as an IRD, or it may be recreated and sent into a bank electronically at will. These concepts are based on the idea that the DC is built around the metadata instruction to send stored in the DCF, and the tracking module 108 may track the various steps by recording data in the DCF. The tracking module 108 provides similar information as a shipment tracking feature, such as with UPS or FedEx. The DC issuer may view real-time status related the DC to determine when the receiver is notified, when the DC is retrieved (which may also tie to an auto-notification feature), and if the ECS is tied into the senders bank account or has a stored value amount at the ECS when the DC was cashed, if and when it is endorsed to a third party, and the like. Additionally, significant events related to the DC may be pre-subscribed to auto notify when they occur. For example, the sender may be auto-notified when the De is cashed.

The tracking module 108 in conjunction with the processing module 112 may be utilized to provide more efficient stop payment service. This feature permits the cancelling of a digital coin/check after issuance by the sender, before depositing into the receivers bank or clearing on the senders account. The ECS 82 may check for a cancellation notice before allowing any type of electronic deposit or IRD printing. This mechanism also affords the receiver with an opportunity to instantly verify that the digital coin/check is good for deposit before IRD printing or when making an electronic deposit request (i.e., they are not offered these options if the digital coin/check has been canceled). If the digital coin/check is cancelled after the receiver makes their deposit (electronically or via IRD), the digital coin/check experiences NSF cancellation means, such as the digital coin/check returned from the issuing bank as being not collectable.

Also, the tracking module 108 may be utilized to provide a DC guarantee service. Here, the DC sender or the receiver may decide (opt-in) to add this feature to the DC. The sender may choose to pay for this when they issue the DC or the receiver may add it when they receive the DC (before cashing/depositing). If the sender did not pre-certify, the ECS 82 may offer the receiver the certification feature using a verification-type service (the ECS may guarantee the DC amount because they actually buy the DC at a discount after they verify it using their PPD and check security and verification methods). Note, the ECS 82 already knows if the DC is valid because the GUID may be checked in real time and verified, such as via PKI for authenticity and non-repudiation. The ECS 82 does not need to keep a list of bad accounts; it has a positive pay database to already know who issued the DC and where to go if it is uncollectible due to a closed account.

The authentication module 110 is configured to provide security relative to creation and processing of the DCFs. For example, the ECS 82 uses the GUID to lookup the DCF transaction and determines how to authenticate the receiver based on the authentication level chosen by the sender when creating the DCF (or setup by the receiver as a condition for retrieving coins/payments from the ECS 82 under a specific name or ID). Authentication levels may include nothing (i.e., just knowing the transaction ID or GUID is enough security for the sender), having a PIN number for the DC, having additional levels of credentials (e.g., account number and login ID into the ECS 66), private digital security signature key (e.g., using a public key cryptography system), or other levels of security agreed to by the parties and supported by the ECS 82.

The processing module 112 is configured to allow receivers 86, senders 88, first deposit banks 90, clearing banks 92 and clearinghouses 94 to process and clear DCs through the ECS 82. As described herein, DCFs are identified through the GUID or the like. Once identified, the processing module 112 enables forwarding or clearing of the DCF. For example, the processing module may generate the electronic image file and send it to the bank of first deposit for further processing by the Item Processing department. As these re-creation requests arrive at the processing module 112, the original metadata values (or the currently stored values) are retrieved from the system and used to re-create the digital coin/check file in X9 format for further image exchange processing. This electronic X9 file may then be sent or routed directly back to the bank of first deposit via a secure electronic link such as the existing Federal Reserve System using the Cash Letter File format. The regenerated image and data values may be generated directly from the ECS 82 and sent back to the bank of first deposit in a Cash Letter File for further image exchange processing and clearing. Thus, this further demonstrates that any items produced by the instant disclosure are built using a fully Coin/Check 21 compliant process from electronic metadata (instructions to send) stored in a database (DCF) instead of handling coins, scanning paper or existing check image data.

In an exemplary embodiment of the instant disclosure, the ECS 82 may be utilized to accelerate ACH-based payments. ACH flows perform multiple steps over a 48 hour cycle to provide a payment between two parties. The ECS 82 may provide real-time clearing features instead of the traditional nightly batch job mechanisms used by banks today. By offering a modem internet web service mechanism through the ECS 82 to ACH originators (businesses trying to get paid) and to banks, the instant disclosure could process ACH requests very quickly or optionally in real-time. Thus, the instant disclosure could theoretically save most of the waste time from ACH payments because the ECS 82 real-time mechanisms take minutes not days. By offering an incentive to the Receiving Depository Financial Institution (RDFI) to retrieve ACH requests on a minute-by-minute basis, ACH payments could also be done in minutes and not one day. The net result may be an ACH payment within minutes, this allows ACH to compete with credit cards, debit, and ATM in terms of speed (which it clearly does not do today). To start with, the ECS 82 could automate payment exchange between an existing billing cycles utilized by service business such as the monthly Application Service Provider (ASP)/website business vendors and any ACH service provider. This web service interface accepts individual account details (or batches of account info) sent to the ECS 82 via a Web Services Description Language (WSDL) generated Web API, this allows ASP and web-hosting centric customers to easily automate their billing system with an ACH payment processor. The ECS builds the National Automated Clearing House Association (NACHA) formatted Automated Clearing House (ACH) file for the item received and intelligently batch them before streaming them into the ACH network for settlement. This speeds up processing, eliminates the older/slower file transfer protocol (FTP) file transfers due to batch jobs, and allows for streaming billing to occur daily. This service also improves cash flow for a website operator, because they get their money faster, and it also jumps the ACH payment to an earlier in day cutoff window for a lower cost transaction (late night jobs cost more). Other enhancements include, automated Acknowledgement (ACK) to your billing system (if no ACH rejection notice was received), automated Rejection handling (with retries), reconciliation etc. which traditionally ACH does not provides to ACH originators today.

In addition to utilizing the UI 100 of the ECS 82, senders 86 could also use a DC device operable to process/create DCs. For example, the DC device could include the metadata on a magnetic strip, smart chips, NFC and the like and process/create DCs at a point-of-sale (POS) terminal by swiping or contacting the DC device at check out Additionally, the ECS 82 may be configured to store credits on the sender's 86 account. For example, when purchasing an item using a DC device, the DC is issued to the merchant, this transaction may be easily reversed if the customer returns the item to the store. Thus, by swiping or contacting a DC device, the ECS 82 may instantly reverse the DC (or cancel it, or issue store credit)—this is easier than putting a stop payment on the DC or waiting for credit to your account. Alternatively, the Merchant may send a DC back to your account instead of a crediting your account. The ECS 82 has a choice—automatically issue the stop payment on the DC or issue a mirror image reversed DC (from merchant's account back to the customer's account).

The DC device may include a plurality of information transmission mechanisms including one or two magnetic swipe strips, a Radio Frequency ID (RFID) chip, a smart card chip, Bluetooth interface, bio-metric and the like. The DC device is configured to transfer the account information (i.e., metadata) into a POS device. The extra strips are to add traditional ACH or Debit card swipe features to a DC device for backwards compatibility with older POS equipment that cannot read the new DC device/DC, format. Also, the instant disclosure allows new POS terminals to be developed that support DC processing/generation via the new or alternative contact or contact-less methods. The magnetic stripe is one way to generate the ISO message format data and check account data to process/generate a DC at the point of purchase.

Additionally, the ECS 82 may be configured to allow the user to link their DC devices with bank accounts, credit card accounts, PayPal accounts, and the like. Thus, the user may choose any payment methods stored in their DC devices at the point of purchase. Moreover, the ECS may be configured to provide the user with functions to link their multiple DC devices under their ECS account and allow them to setup, manage and control their DC devices for sending, receiving, depositing, transferring and monitoring. For example, the parent users could link their children's DC devices under their ECS account. The ECS provides functions allowing parents to setup the period of fund transfer to support the child's daily expense and providing reports of their spending activities. Therefore, the parents may easily control, monitor their children and no longer need to give cash as allowance. In other words, it may provide prevention to their children buying illegal substances.

In another exemplary embodiment, the ECS 82 may be configured with the App allows the users to deposit/withdraw cash from people nearby. For example, the ECS App uses global positioning system (GPS) to locate any DC users including merchants nearby as ATMs or cashiers who want to deposit extra cash or willing to be withdrawn. Thus, this method offers low cost, convenient and flexible systems for users to deposit/get cash fast with nearest location.

Additionally, the ECS 82 may be configured to allow the users to convert stored digital coins into any different currencies. This is useful for users who travel a lot in foreign currencies and the users may utilize the DC device to shop anywhere of any country which has deployed the ECS. Thus, this method offers low cost, convenient and flexible systems for travelers.

In another exemplary embodiment, the ECS 82 may be configured to generate a DC from a credit card payment. This may create a cash advance by allowing a DC device holder to convert a charge on their credit card into the DC. Currently credit cards issued by Visa and Master Card and the like may offer cash advances, with DCs, the ECS 82 could allow other businesses to offer this. This mechanism permits the business to create a DC on behalf of the Visa or Master Card holder, similar to a cash advance and then cash the check as payment fulfillment. The customer notifies the ECS 82 that they want to make a DC from a credit card transaction source, the ECS 82 acts as the merchant acquirer, and switches the payment over to the DC which they then treat as any other check, the funds are provided by Visa or MasterCard and made payable to the DC issued by the ECS 82.

Additionally, the ECS 82 may be configured to include a payment statistics database based on historical data of DCs. Here, DC that are processed/created may contribute to the database which collects coin/payment statistics (like user demographics, payment amounts, rates of payments, etc.) on individual users and their corresponding payment histories as well as on overall coin/check market statistics. The individual user statistics may be used to generate a FICO-like (Fair, Isaac and Company) score for rating user risk for DC clearing (i.e. do they bounce a lot of DCs?). The overall DC market statistics may be sold to academic researches such as the Federal Reserve payment studies as well as to other parties such as consulting services wishing to establish benchmarks, standards or minimum score targets for their customers. Example statistics tracked by the ECS 82 may include DC clock time (average time to clear a DC), length of time to send, receive, deposit or cashing, average number of receivers, average DC TTL, and the like. This tracking creates an opportunity to perform Data Mining on DC senders and receivers and sell this information into the market for those who want to know more about customer or business behaviors This also allows the ECS to issue a rating system, such as the quality of the sender. This presents the receiver with a numerical value that expresses the quality of the sender as far as the ECS 82 knows about their history. This uses the audit trail and DC history to calculate a numerical value that measures the credit worthiness of the sender (e.g., how well their DCs clear, NSF rate, average clearing speed, etc.) This may be an issuer controller feature (they could send out their rating or not), the score is kept/updated on the backend so the value is there—the sender could optionally control whether the receiver sees it or not. It is envisioned that in one embodiment the system provides a payment score from statistics, wherein the payment score comprises a rating for a sender associated with the digital coin check.

The ECS 82 services may include numerical calculators or accounting applications configured to convert payments into different currencies, such as for future DC issuance. This is useful for senders 86 who make a lot of payments in a foreign currency. This application takes the payment amount, and reverses the current exchange rate for some short term, future use, when issuing a DC using the TTL feature. This feature is different than existing currency exchange rate lookup services or nightly payment exchange services in that it would be based on a TTL clock set in the DC record. The reservation of the future rate is recorded, and a contract is issued automatically into the ECS 82 DCF and stored in a DC record to be fulfilled/used later at DC creation time. If the DC is not issued in time, the rate expires back to some pre-set default or the ECS could use the current rate whenever the DC was finally authorized for sending. This allows business or sender to hedge their currency bets against future currency conversion rates by allowing them to lock in a current rate now, for use with a near term future coin/check payment made under a separate DC authorization step. Thus the Treasury Management department services offered to a large corporation could pick the best rate of the day and lock it in for use on the accounting systems DCs based coin/check run that day or night.

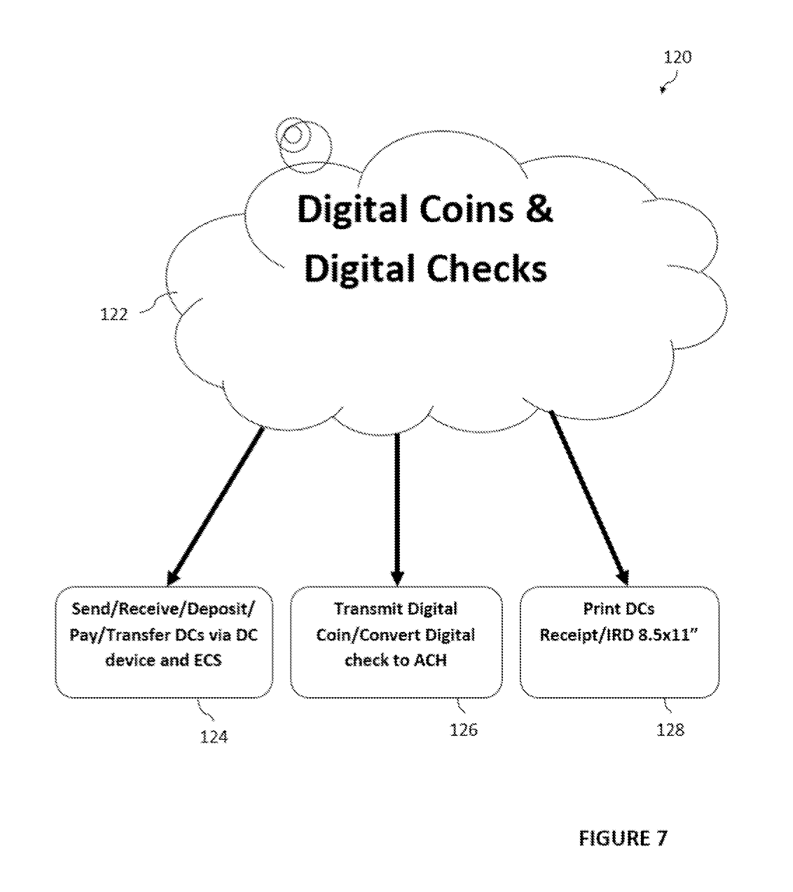

Referring to FIG. 7, various delivery mechanisms 120 are illustrated for DCs utilizing the ECS, according to an exemplary embodiment of the instant disclosure. First, a DC is electronically delivered (step 122). The ECS may provide delivery of the DC through any mechanism including email, fax, text message, instant message, phone call, page, and the like. After delivery, a receiver may utilize several deposit mechanisms with the ECS.

When someone receives a DC notification via email, the instant disclosure may automatically know that it has a valid or good email address, i.e. the ECS may build a positive white list of good email addresses (vs. a negative black list, which is a list of known spammers). Using the ECS, the DC metadata contains receiver email address metadata which is used to create a list of known good email accounts, versus dead email accounts; this is true because if the ECS was able to successfully notify the receiver that they have a DC (via email) and the receiver comes back into the ECS to pick it up, the ECS knows that it has reached the receiver via a good email address. Also, alternatively, the ECS could provide a validation or verification service to well-known SPAM filter services operating in front of email services This means that a SPAM filter service could ask the ECS to verify an email address from the ECS white list and decide to either let in an email message or not. Thus, the ECS may rely on the fact that recipients of DCs via email automatically create a white list of known good emails for anti-SPAM services. The concept of providing a valid value transfer notification method (the email notification) allows additional services to be built which extend outside of the traditional payment services offered by ECS.

The ECS may offer additional services to the sender and receiver such as providing the concept that delivery of the DC may be automatic, e.g. an auto-escrow confirmation service via a shipping notification method. This is an automated mechanism to trigger payment of shipped goods when electronic shipment tracking notification is published to or consumed by the ECS. This feature ties the conditional payment control features of DCs to the existing shipping or delivery supply chain channels as one of the many workflow steps that may trigger a DC to be issued/released/paid, etc. For example, when a person signs for receipt of package delivery such as UPS or FedEx and the like, the delivery service may send a signal to ECS to automatically generate a DC to pay the shipper or the delivery service Thus, continuation of delivery means that a payment may be issued to someone as a condition of escrow fulfillment.

Further, the ECS may provide COD (check on delivery) using DCs tied to a shipping system. Payment on delivery is made when a user signs for their package with the shipper, the computer inside the UPS or FedEx signature capture pad notifies the ECS to cut a DC to the shipper using the PO/shipping, invoice as evidence along with the recipient's signature verifying that they received the item. This feature helps facilitate easier, faster and more reliable E-commerce purchases in the absence of a credit card or the like. Alternatively, this may be used by a business where the billing address in the credit card file does not match the actual shipping address and pay for delivery of an item ordered over the Internet, traditionally, shipper may not be allowed shipment to non-billing addresses. Shippers may trust that a DC will be sent when the shipper drops off the package because having the customer sign for delivery confirms that they are to be paid,

Additionally, the ECS may provide a conditional payment service where contract acceptance is done to cash the DC. This mechanism is useful for promotional or marketing campaigns where a business may send to a customer a promotional check which contains a contract on the back of the digital check. When a consumer (as receiver) signs the check to deposit it into their bank account, the consumer is also agreeing to the contract, thus the company (sender) may begin to charge them for the product or service described on the promotional check. Endorsement rules apply and an automated payment agreement is added to the endorsement line. This mechanism has the receiver of the DC to check a box and agree to payment terms before they may deposit or print the IRD. Note here, that the business doing the promotion is the original sender and the receiver is the targeted customer, the goal being to let the business doing the promotion to setup an automated billing method using DCs via agreement to the contract. So while the consumer (receiver) initially gets to receive the DC, once they agree, they may have future DCs generated by the ECS payable to the original business promoter to pay for whatever monthly service they agreed to or signed up for. Note that the process started with the business as the sender, then they become the receiver after the initial promotional DC is deposited and recurring payments are made to maintain the service or agreement.

Once received, the receiver has several options on how to proceed with the DC, such as deposit via ECS (step 124), DC transmitting or conversion to ACH (step 126), printing a receipt/IRD (step 128), and the like. Once the receiver has been notified, the receiver uses the globally unique transaction ID (GUID) which was provided to them in the notification message to identify which specific DC they wish to retrieve. The ECS uses the GUID to lookup the DC transaction and determine how to authenticate the receiver based on the authentication level chosen by the sender when sending the DC (or setup by the receiver as a condition for retrieving payments from the ECS under a specific name or ID). After satisfying the authentication and security tests, the receiver has a choice in how to proceed with the depositing or clearing the payment for credit to their account. After retrieving the DCF record for the specific DC (using the GUID), the ECS may generate a DC image (in Check 21 image format) and display it directly onto a website page in order to present to the receiver the specific DC image for the payment they have received. Viewing a payment in DC image form allows the receiver to confirm that this is indeed the payment they expected, that it has the correct receiver name or identifier on it, it has the correct value amount and has other optional business rules and processes attached to the payment which the receiver may confirm prior to depositing the payment.

First, DCs may be deposited electronically, such as through ECS (step 124). This provides a mechanism for deposit into a bank instead of handling coins/scanning an IRD. For example, a sender may use a web appliance (e.g., embedded computer system) which processes Simple Mail Transfer Protocol (SMTP) email sent to a mailbox at a bank identified with a well-known address such as Deposits xyz.com email inbox address. The bank or business may receive DCs via email, and the appliance strips out the GUID from the DC notification message, and generates an automated electronic deposit request or generates an actual X9 image cash letter for deposit and sends the file to the banking system for settlement. Thus, there is no human intervention—no opening of letters, no coins, no paper check or IRD scanning in order to deposit the DC. A middle man service such as an EPCH may facilitate the clearing process of these automated deposits. Unlike one of the ECS methods where sender and receiver are humans interacting with the system; in this model, a sender pays the bill to the business via their public deposit email account and the appliance automates the electronic depositing of the DC. This replaces the traditional banking lockbox service where humans open up mail and scan a paper check to then ACH (ARC) the deposit into the businesses deposit account. This method is faster, easier, and more secure and provides a lower cost method of electronic bill payment collection. Optionally, a receiver may forward or push their DC to a local merchant store to get instant cash (versus depositing and clearing) using traditional check cashing techniques and methods. Also, the ECS could permit a DC cashing merchant to pull the DC into their system so the receiver may walk down the street to quickly cash the DC. Also, the clearing/payment may be made faster via electronic deposit into the merchant's bank account so they have better turn on their inventory of cash.

Cash deposits could be made into a DC account by using numerous deposit only accounts or one time accounts and the like at mainstream banks (i.e. popular banks with locations across the U.S.). If the ECS had accounts that customers could make cash deposits into, the ECS could allow many to deposit cash into their stored value account maintained by the ECS, and thus allow senders to quickly fund a DC by using walk-in deposits of cash at a few accounts at the top 10 banks. Deposit slips could be printed from the ECS website with the ECS DDA deposit account information pre-filled into the deposit slip, thus allowing DC customers to walk into the nearest top 10 bank branch and deposit cash to fund their next DC. The ECS system could track these deposit accounts in real-time using the ATM network and know when a depositor went to a specific bank to fund a specific account with a specified amount given the deposit slip information via the DC deposit slip GUID. Verification of this information reconciles the ECS bank account with the customer stored value account.

In another exemplary embodiment, the receiver may convert a DC into an ACH payment to clear through the ACH network (step 126). Here, the DC item would be converted to an electronic payment under the ACH network rules, and clear through it. Alternatively, the ECS may perform an ACH to DC conversion. Here, the ECS performs a reverse or undo ACH feature checks are converted into ACH items then the ECS may create a DC from an ACH file. This is an anti-POP feature that allows banks or clearinghouses to re-route/re-claim ACH payment flow back into the check network because the payment is now a DC (a real check). This also allows a business to do a least cost clearing method and take existing ACH payment flows and route them back into the checking rail network. Basically, the ECS takes the ACH file and extracts out the DDA (checking account) metadata to generate a DC from the information that already exists in an ACH message. Additionally, the ECS may convert an ACH item to a paper check item. This is similar to ACH to DC, this truncates ACH back to a paper check. This is the opposite of POP and ARC.

Additionally, the ECS may provide a DC lock-box service to replace traditional ACH check truncation mechanisms. Here, DCs are electronically forwarded to banks after applying traditional payment lock box functions. This feature performs steps such as identifying which account number to apply to payments, verifying amounts, receivers account, etc. This also allows high volume balers to easily receive DCs and have traditional lock box services applied to DC payments. This concept may apply to an Electronic Bill Presentment and Payment system or an EPCH system and the like.

The instant disclosure supports a novel automated method for printing Coin/Check 21 complaint IRDs by senders using automated pre-filled in DC forms. In an exemplary embodiment, the instant disclosure supports form-fillable generated IRDs, such as through Adobe Acrobat PDF form reader programs and the like. A user goes to a website, fills in an ECS webpage form with their ABA routing number of their bank, and the service generates a blank DC template saved in PDF form with intelligent macro features. This allows the ECS to get and correctly set the Magnetic Ink Character Recognition (MICR) font/MICR line in an IRD to the correct fixed position inside the IRD form layout. Whenever the ECS generates the PDF form it may take the user provided ABA MICR line information and auto-generate it into the IRD which is stored as a PDF. The user downloads the PDF form to their PC, they open the PDF form, fill in the blanks for receiver, amount, date, etc. and save or print the form as an IRD DC file. This file is an X(IRD, with tilled in data values, the coins/check, which is drawn on the senders ECS/checking account and clears as a check using traditional coins, paper check or Check 21 methods. The user may email this PDF DC file to the receiver as an email attachment, because many have the free PDF viewer (or has access to it), the receiver may easily open the file in their viewer, and may print the DC for deposit, optionally the receiver may fill in a deposit form attached to file, or email form to their bank for automatic deposit using the ECS deposit method.

Additionally, the instant disclosure contemplates a high-volume check printer method and system which creates full check image from DCs. With this idea, DCs have no need for coins/pre-printed check stock, (used by high speed line printers where the paper has tear-off side strips for example). This method allows DCs to be printed on real check stock for high speed IRD printing in order to become a paper check. For business check issuers, this gives them an in-house DC printing service (or outsourced) that prints a DC in paper form for any receiver who does not have an email address on file. The paper check stock may include a barcode for a Coin/Check 21 IRD. For example, check printers like Harland or Deluxe may add barcodes to their form to identify which layout and sender data was used to create that DC check. This eliminates some of the optical character recognition (OCR) labor to convert a paper check back into a DC. This method is a half-way step between the old coin/paper Item Processing methods and a digital DC process. The barcode could be scanned to identify the DC check template and sender metadata, then the remaining fields would be Optical Character Recognition (OCR'ed) to find the amount, receiver, date etc. and the sets of data are merged into a DC record.

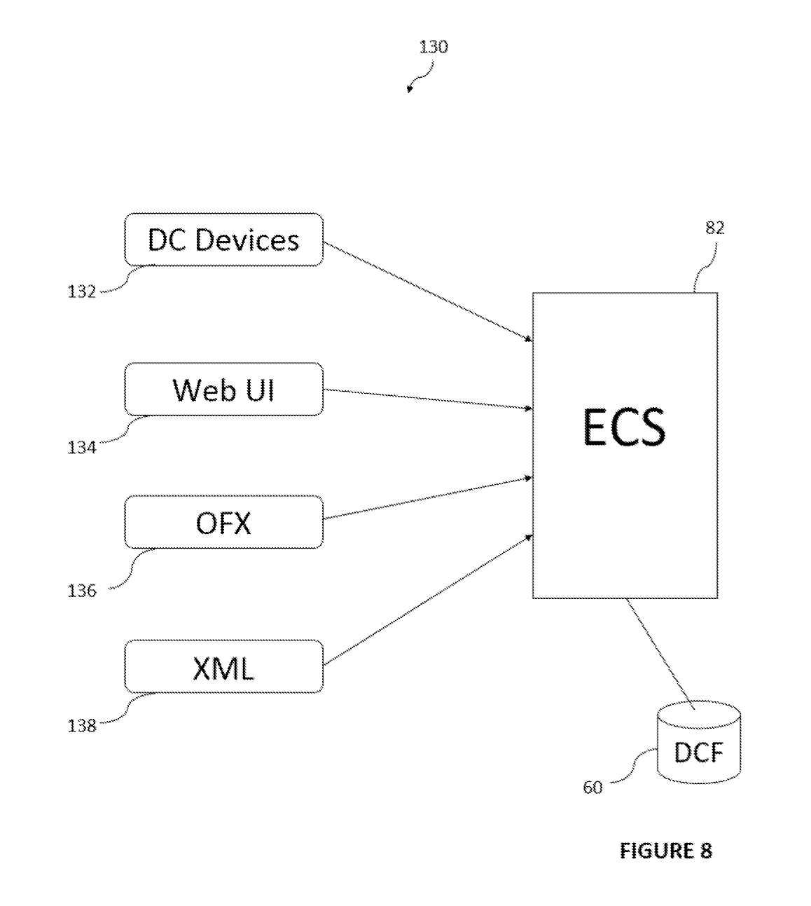

Referring to FIG. 8, DC creation mechanisms 130 are illustrated according to an exemplary embodiment of the instant disclosure. DCs may be processed/created through a variety of mechanisms, such as directly through the ECS 82 through a DC device 132, through a web User Interface 134, through an Open Financial Exchange (OFX) file 136, through an Extensible Markup Language (XML) file 138, and the like. As described herein, the DC device 132 allows sender/receiver to process and create DCs through D2M/D2D. The UI 132 allows users to log in the ECS 82 and directly create DCs. The OFX and XML file methods allow for automated or accounting software driven DC creation input methods. Once created, the ECS 82 stores the DC in a DCF 60 file.

The instant disclosure may utilize the OFX (Open Financial exchange) 136 to allow third party software to create a DC. Here, senders may use Quicken or QuickBooks, for example, as their payment issuing mechanism. For example, a sender would utilize some command, such as Vendor Pay Bill (or whatever command is used to issue DCs), and the instant disclosure utilizes a software plugin that captures coin/check metadata from the software program and use it to issue a DC. Here, the software plugin writes out an XML, or OFX format file that captures the coin/check metadata and sends it via a web API into the ECS 82 service on behalf of the user. The OFX file has the same coin/check creation instructions as a human utilizing the ECS UI, this data is generated inside the software program (not the ECS website) and then saved to an OFX file and then uploaded to the ECS 82 to generate the DC. Note, existing software does not need to be modified to support DC creation. The instant disclosure just uses the existing API add-in mechanisms to install a plugin that understands how to generate a DC via OFX or XML files. In the reverse scenario, using the ECS 82 website, DC creation steps may also generate an OFX file to update the local software accounting database with recently issued DC payments so that they may be recorded and reconciled within the accounting or business software system. This means that the ECS 82 would generate an OFX file that a user would download into accounting software which contains instructions which the accounting system uses to update records.

Additionally, the instant disclosure contemplates auto-DC generation via XML Electronic Data Interchange (EDI) standards. EDI was the original purchase order/invoice automation method started back in the 1980s. Then in the late 1990's, business tried to improve their existing Supply Chain Management (SCM) functionality by integrating their Enterprise Resource Planning (ERP) systems which their SCM software which automated the Account Payable (AP) function, a business may manually cut a check to pay for the automated invoice. By integrating DCs into ERP or accounting software, high volume AP check issuers could automatically generate a DC when they receive a properly formatted XML Purchase Order (P.O.'s) or Invoice. If proper XML EDI instructions are received (from a known registered supplier), an accounting system may automatically cut a check and generate a DC on the fly, assuming that the managers of the business have set or allowed business rules to make this happen. This simplifies the Account Payable service and enhances EDI type of exchanges for B2B extranet scenarios between suppliers and customers. This ECS method is useful for Just in Time (JIT) inventory situations where manufacturers re-order supplies, vendors want to be paid faster as well, i.e. the ECS provides a just in time payments system to close the loop on exposed by the JIT inventory systems. This idea has the ECS 82 to support some type of published or well-known XML schema(s) for integration of PO's and Invoices with SCM and ERP systems.

Additionally., the instant disclosure contemplates automated merchant processing for transaction risk placement. Here, this automated mechanism transfers payment risk when issuing a DC. Essentially, at DC creation time, senders are offered an optional feature of selecting from a list of institutions who are known to be willing to buy the risk that a transaction payment will go had (for example think factoring, payment insurance or certified payments and the like). This works for senders certifying their DC or for receivers receiving either a high volume of DCs or DCs with large, risky payment amounts For example having senders pay for insurance on their DCs (note insurance is instantly confirmed with the authorization of the transaction) to incentivize receivers to be more willing to accept DCs as satisfaction of the debt. Thus, this service allows DCs to be accepted by more people including businesses who rarely see the sender due to the disconnected nature of Internet based transactions (E-commerce) and particularly of DC generation by some new ECS or EPCH service. Alternatively, for receivers, the risk transferring institution may be selected based on the analysis of the transaction and their outstanding balance and their credit history. Thus, merchants could sell off their outstanding nightly receivables balance to get their money faster by accepting a 95% payment from the factoring/risk taking institution. These mechanisms could be offered by the ECS and used in either DCs or with other payment methods like credit cards or ACH. Using this mechanism, the ECS 82 could speed up the traditional two day ACH clearing process.

The ECS may support numerous usage concepts leveraging the flexibility of the coin/cheek system and the stipulations of E-commerce. For example, DCs could be used as better coupons for immediate in-store credit. This allows merchants to issue limited time promotional coin/check as part of a sophisticated marketing campaign. For example a 10% off coupon for a new item may be sent to many users (new or existing customers) using a DC coin/check sent via email. The user could print the IRD and walk in to the store with the IRD coupon to buy the item. The coupon (an IRD with the items Universal Product Code (UPC) barcode preprinted on the IRD) discount gets automatically applied at checkout by a POS terminal. The idea is to verify the credit value in the store (online or brick and mortar) at checkout using the UPC barcode and make a payment or receive a discount quickly. Using this novel ECS method, any business may easily send out a rebate check to drive customers into the store to spend the coin/check. At checkout, the POS inputs the GUID and a discount is applied. The GUID is canceled to eliminate duplicate coupons as well as provide merchants with an automatic efficiency rating and tracking system to show them who used the coupons, when, where etc., tying database marketing and data-mining to coupon present captured from POS data. This method may also be used to issue store credit or scrip that is good for in store use, it may also be traded to others to allow some external value to be kept (like the old Green stamps). A website or web service validates the DC coupon at POS scanning, verifies it and automatically deducts the amount from the pre-funded DC account setup by the manufacture at the ECS in order to credit the store's ECS DC account. This provides faster payment to the store, easier and more accurate tracking to the manufacturer for the DC coupon distributed with better security features given existing DC GUID security.

Additionally, the ECS may offer DCs which may be auto-filled by merchants, allowing the sender to sign and submit for payment. DCs may be pre-filled by merchant with information and receiver bank account information (acquired by the ECS from previous DC payments or deposits) including customers previous selections for coin/check issuing options (elected by the issuer), so the DC is waiting for the customer and ready for them to sign or authorize the DC. The merchant prepares the DC and has it waiting for the receiver to sign/issue.

For small and low risk amounts used in cross promotional campaigns, DCs may also be printed in traditional store coupon form with a Universal Product Code (UPC) code representing the discount amount, e.g. 50 cents off some product. Here, a manufacturer may control the issuance just like a check including PPD (positive-pay) features. A buyer could take the DCs to the store, scan it at checkout, and deduct the amount. The value is transferred via the coupon network/rail/clearing system NOT the bank or checking system. This method converts DCs to coupons and clears them via the traditional grocery store coupon system for reimbursement by the manufacturer or coupon issuer back to the store. Note, this may also work for Health and Human Services (e.g., food stamps). A food stamp user could take the DCs to the store, scan it at checkout, and exchange the food. The value is transferred via the food stamp network/rail/clearing system. The method converts DCs to food stamps and clears them via the traditional food stamp system for reimbursement by the government.

The ECS has additional methods to help fundraising efforts for charities, donations, projects (Kickstarter) and the like. ECS generated DCs offer superior speed and lower costs features to charities and non-profits which benefit from the reduced expenses (compared to credit cards), they also keep more of the donation compared with other alternatives, and they are easier (compared to ACH) and faster to receive. Thus an ECS service could be developed to utilize DCs in an ASP model to bill church goers for regular tithing amounts such as weekly or monthly recurring payments plus automatically generate receipts (canceled checks) to prove the donation was made. The church member signs up using a church branded ECS website (ex. FirstATLChurch.PayBanc.com) and sets an amount and schedule to be drafted and sent as a DC (not ACH item or credit card charge). Note, this may also work for colleges (e.g., alumni association), other 503(c) charities (e.g., Red Cross), for membership drives (email a check to join), for one time disaster relief services, and the like. The ECS DCs method is safer than ACH and credit card methods, protects consumers and gives them control over how the DCs is written, while the charity gets a super low cost and efficient collection method.

ECS generated DCs methods could also be used for expense reimbursements systems. Here, DCs and the ECS could integrate with existing expense reimbursement systems for easy, quick checks to employees (such as low value checks for office supplies, eliminates the need for petty cash/coins in the business). Many ASP applications exist for expense tracking, and the like, they do not integrate with ERP/payroll services. Using the ECS, employees utilizing these services would not need to wait once or twice a month for the business to cut checks to receive their expense check. Also, DCs and the ECS could integrate with payroll services for fast, efficient payroll checks (instead of ACH direct deposit). This may work better, faster and cheaper for small business than the traditional payroll services. The ECS payroll service may also tie into the optional data area on IRD to on print data such as year-to-date tax, withholding amounts, etc. and have the DCS emailed to remote employees. Additionally, small businesses or home business senders could use the OFX integration described herein to automatically generate ECS payroll payments from their accounting software on a regular/scheduled basis. These methods offer low cost and flexible systems with total control by the business because the ECS allows them to issue the DCs and direct where they will be sent, the ECS provides them full control over the DC payments.

ECS generated DCs may be attached to an electronic greeting card as embedded payments for birthday's, graduation gifts, etc. This allows ECS users to send greeting cards to people along with the ability to send money as DCs along with the e-card. Paper cards have had an advantage of being able to attach cash or paper checks inside the document. Now with DCs, the online greeting card systems may finally do the same thing for electronic cards.

An additional novel and innovative concept provided for by the instant disclosure is the feature that the ECS may provide an efficient origination mechanism for small, micro payments. Utilizing an ECS web service either ACH or DCs could be generated as the final payment mechanism for the micro payments. For example, slower clearing of small value payments may be acceptable to some; the problem in the industry has been how to allow a business to originate this small value payments efficiently/easily/automatically. For example, how would a traditional payment rail or EPCH allow a business to efficiently and cost effectively originate a 5 cent charge for viewing a webpage news story per user per view? How would the business invoice the user or collect this small value payment from the user? Traditionally, generating an ACH item per small item is cumbersome and costly, and credit cards are too expensive. Thus, using DCs or the efficient ACH methods discussed, the ECS service could clear the many small payments efficiently either as a payment (billing the user for the total page views during their session) or optionally as individual small DCs generated per page view (this assumes that the ECS or EPCH has an extremely cost efficient and automatic method for origination and settlement to avoid the clearing charges being greater than the DC payment value). The instant disclosure could make a low cost deduction from the buyer into the sellers account. Also, the instant disclosure could use a slower payments model when the clearing time is not critical, the ECS does not need to generate a DC, it could use the improved ACH methods as an alternative. This micro billing and payment service utilizes the easy, efficient (web service), methods provided by the ECS and optionally may group or chunk the payments into batches (per user defined period). For example, the ECS could offer a virtual Newspaper Boy feature for weekly collection of web newspapers delivered by an ASP or online service. The ECS micro-payment method could also provide a form of payment, referred to herein as web coins, which demonstrates that the ECS micro-payments web service provides a virtual coin box. The ECS service could collect nickel type payments deposited by senders utilizing ECS enabled E-commerce websites and provide the website business owners with collection services which deliver these web-coin payments on an efficient and regularly scheduled basis (ex, think of a web based coin-box that is emptied weekly by hatching the ECS DCF records into a DC delivered to the website owner).

In another exemplary embodiment of the instant disclosure, the ECS may provide micro-loans to other ECS users easily and efficiently through DCs. This method allows an ECS customer who has a stored value account to make a higher yield on their savings (stored value) in a DC account. The idea is to allow the ECS user to loan out their excess ECS account balance nightly like commercial paper loans in order to earn a higher interest rate on their deposits. This allows end users to participate in the float game, for example an ECS user may have an average weekly balance $100 and decide to loan $50 out weekly if they don't need it at a good interest rate. The loan is to another customer a small, quick loan to cover a DC payment (real fast, similar to overdraft protection concepts and the like). The customer agrees to pay nightly or weekly interest and the ECS system would lock them out of borrowing if they borrow too much (setting some consumer limit such as $100 maximum) or if their ECS tracked credit score falls below some limit. The micro-loan has a contract (tied to a DC loan) and is paid back via a DC that has workflow/escrow/conditional features enabled (i.e. the sender can't write other DCs while they have an outstanding unpaid loan for example) this helps the FCS to make sure that the micro-loan borrow will repay the loan quickly.

The DCs and ECS enable other types of micro-payments electronically via checks. Traditionally, business resist writing checks for small amounts (under a $1 for example) as the cost to print and mail the check exceeds the value of the check. The FCS may enable a new form of micro payments suitable for these less than one U.S. dollar type payments such as quarterly dividend payments for small stock holdings. The micro payments may be made efficiently and easily with DCs while retaining the present infrastructure. For example, sending a 50 cent check (e.g., for a dividend check) is now feasible because of the low costs of DCS, thus these types of payments become more feasible or realistic to businesses to make small payments plus the receivers benefit because these small DC payments may clear through the existing check infrastructure. No postage is utilized, no delivery costs, etc. thus this ECS service makes sub one dollar payments efficient and feasible while keeping the senders and/or receivers present infrastructure.

DCs may be created and then converted to cash using a truncation of the coin/check into a money order. The ECS may offer other coin/check cashing services and features which may be applied to simulate money order payments with easier creation/authentication and security mechanisms. Creating a DC, one of the choices may be to make a Money Order (MO) instead of a DC. For a small fee, when the ECS sends the DC style money order out to the receiver/recipient, the receiver has the option to direct the MO to be sent to a local store for immediate cashing. This saves time and effort, and allows the store to utilize the ECS provided identification methods using a PIN, etc. The ECS may also partner with ATM/postal service money orders (because there are ATM/Post Offices are widely available) or with financial services companies for Travelers Checks. The ECS could also partner with Banks to dispense cash for these DC to MO conversions for a fee. Optionally. DC may be converted into a more secure MO with specific payment instructions (PIN, who to pay, etc.) so the receiver with proof of IL) may walk in and get the money (even at a foreign bank), this makes DC based Money Orders work like a universal check.

Additionally, the ECS may provide an electronic bill presentment system with easy auto pay type features added to their electronic bill presentment (EBP) message. An online bill presentment vendor embeds a pre-filled in DC inside the electronic bill presentment file sent to the customer (the receiver is the customer of the EBP vendor). To pay the bill with a DC via the ECS, the bill presentment recipient may click on the embedded DC receiver URL link to quickly and easily pay the bill (the URL link contains the DC GUID) from their checking account. The biller has pre-filled their account info along with the customer's info into the pre-paid bill which is stored in a link in the ECS DCF. The DC user receives a notification that they have a bill not a check so they go online to authorize the DC transfer to pay the biller. This ties to conditional payments features and contracts, plus file append features, for example, the bill info is appended to the check/stub. This feature provides better features to bill senders than the well-known alternative of establishing an ACH auto-draft contract where the customer (sender) has trouble trying to cancel the auto-draft when they cancel the service. Here, the customer authorizes the payment monthly, thus when canceled, the ECS stops sending out bill notification to the sender, thus the original biller has no way to receive any type of automated payment. The person receiving the bill authorizes the creation of the DC, this just automates and integrates bill presentment with DC generation services provided by the ECS.

Existing online bill payment (OLBP) services e.g., CheckFree) use ACH or paper checks, and the instant disclosure allows the ECS to add DCs as a new payment option with on-line bill pay. Users may choose this option to get enhanced tracking, security, conditional/contracts, etc. This mechanism adds value, keeps costs down (vs. coin/paper check) and clears as a check, not ACH truncation. Additionally, this feature may also be used by a small bank that has an existing outsourced or hosted software solution to easily offer in-house OLBP to their customers. Effectively, DCs and the ECS may provide an improved OLBP system with DCs tied to paper bills for payment. A paper bill is printed with a DC code that identifies the amount and who to pay (receiver info). When the customer (sender) opens the bill, they will see the ECS code which allows them to go to the ECS enabled online bank service to generate a DC payment. The customer enters the billing code to automatically have the amount, receiver, account info, etc and the like automatically generated for them onto the live, online DC form. This feature makes paying your bills very easy and fast, better than existing Online Bill Pay. Using this method, by entering one GUID the sender may automate the process, even if the monthly billing amount varies (existing OLBP makes you type in the amount, the ECS already knows this dynamic amount when it is coupled with EBP). The ECS is a new, novel, and open to anyone digital coin/payment service. Using DCs, the ECS may offer online check issuing, different than Online Bill Pay. The ECS may also link to Online Bill Presentment systems and pay instantly, one feature is online coinless/paperless Check 21 payments, not ACH transfers or Credit Card clearing.

Additionally, DCs may be certified online. Using the ECS, either sender (pre-certified) or receiver (after receiving) may decide to elect to pay to certify that the funds are good or guaranteed. The ECS may offer multiple levels of certification. Certification is tied to the bank account (DDA), the ECS receives a request to certify and goes back to the issuing account, inspects the balance (e.g., this may be done via ATM network), and verifies funds (similar to credit card pre-authorization) or to collect the funds to ensure that the DC will clear. For example, a user elects to do this by checking a box in an online form, this feature links to check control features and issuing control features. Current online payment systems do not certify checks, instead they used stored value amounts to issue bank checks to avoid double debits at pre-certified checks. Thus the instant disclosure may certify the DC to be the functional equivalent of a bank DC.

The DC may also be used for online loan creation, tracking, and payment. This is intended for personal and small business loans. This ECS process assists in the creation of the loan agreement, payment of the loan, tracking of the loan on-line, enables auto-payments through various methods, utilizes pre-filled in DCs, etc. The DC is tied to a loan document using a contract or conditional features which are attached to the DC. This lowers the cost to issue loans because there would be an automated way to track and make payments.

The ECS may also tie into other E-commerce payment systems, such as PayPal and the like. Here, the ECS could front end a user's PayPal account by using APIs to poll their account status, or initiate PayPal payments from the ECS using APIs instead of user input. This makes the ECS useful to the die hard PayPal users, allowing them to use an ECS account While reviewing one payment account. The user would use ECS as their online payments service and instruct it on how to manage their PayPal or other stored value account with their DC devices. This feature may work for any type of online account, allowing the ECS to consolidate multiple money management services into one,

In another exemplary embodiment of the instant disclosure, using a real DC device operable to process/create DCs, users may accumulate reward points for the DC issued, the total number issued, the value issued, etc. and many other metrics. This feature may tie back into the data collection/demographics feature so that merchants have a better idea of who their customers are.

DCs may also be pre-funded, i.e. one time or multi-use, from a drawn down account. Here, users pre-fund an account, and the GUID for that account is then given to a creditor or business who bills regularly against the account (for example, useful for retainer based services). Additionally, they may draw down on the account monthly for auto pay type feature. Note, the ECS makes sure the balance either does not go below some threshold or it may go to zero and a new pre-funded account may be created periodically. This eliminates the ACH contract cancellation issues seen by users of existing auto pay services. This may be tied to the auto-replenishment features to refill accounts. This feature also secures the sender's checking similar to the new ACH credit push concept, the sender may safely put the money into a separate account that a creditor has access to (not allowing access to the primary account).

Rebates may be provided faster through the ECS. Using the paper receipt mail-in rebate process, a rebate processor may utilize the customers email ID typically provide on the rebate submission form to offer the customer an instant rebate. The ECS enables this service to the rebate process and their customer for a fee (typically paid through a discount on the rebate check) via an instant DC sent via email versus having them wait for a 6 week delayed paper check. The customer incentive is to receive a faster (discounted) rebate coin/check via email instead of waiting 4-6 weeks to get a paper check. Incentives to manufacturers are better customer tracking (the ECS automatically notifies them a list of who opted-in and may provide them with a list of email address to continue to market to them or optionally have the ECS send them a survey). Note that the loss of float by the rebate fulfillment service due to faster clearing is offset by the ECS offering to split the revenue generated by customers accepting the instant rebate.

Further, DCs may be used to provide instant POS rebates using an email ID. Here, the instant disclosure could allow manufacturers to issue DC rebates to customers using the stores POS terminal. This method has the in-store POS system configured to interoperate with the ECS and to collect the metadata such as the customer email address. Optionally, the rebate may be applied like a coupon by printing out the DC as an IRD or online. Further, a user could transfer the rebate amount to somewhere else using their email ID to create a DC which you send someplace else (instead of instant discount), like banking a rebate to your piggybank.

DCs are flexible through the ECS. For example, a receiver using the ECS to retrieve a DC could repurpose the DC instead of cashing or depositing it. The receiver does this by splitting up the total value they have received into multiple payments to other people (note sub-payments total 100% or the original DC amount). The receiver may split a DC out to multiple people utilizing one check. By doing this, the check issuer and original receiver may get a history of the DC (tracking of receivers), data is kept in DC DCF record to see where the DC went, the audit trail is preserved. DCs received as a gift may be converted (repurposed) and used to buy store credits for items, such as with gift certificates and the like. Optionally, when a sender auto budgets their paycheck or spread X dollars across a list of receivers this feature would come in handy. This feature will automate the spreading equally, or by percentage (user defined), etc. to receivers listed. The customer provides the receiver list and the amount (total value) and how to split or spread (optional). Here, the sender is choosing how to spread the value versus in repurposing the receiver chooses who to send value to (by forwarding the DC on to a 3rd party)

The ECS may provide a smart checking account with auto-replenishment. This is not overdraft, instead a user sets the threshold/limit where money is automatically pulled into the ECS account. Auto-replenishment ensures that a customer's DC account is kept enabled by automatically drafting an existing checking (DDA) account and storing the value in the ECS account or other stored value account service. This could be used to notify people that their PayPal account has run out of money (user set threshold), for example. This allows users to link to a stored value account to a real checking account and move money via ACH or check to their PayPal account in an automated manner. Note, the ECS could do this automatically, PayPal does not, so this is a useful add-on to PayPal. This may work with any type of online service, front end aggregation and value mgmt.

Using a DC device through the ECS makes it possible to spend stored DCs received by a receiver. These checks are waiting at the ECS, and they may then be cashed at merchants using their DC device. Unlike third party checks, bad checks may be traced and collected back to the issuer if they are DCs. This implementation utilizes a DC Device updateable via RFID, smart card chip, or some upload mechanism and the like. The ECS may also store coupons. Coupons are stored in a database that have been accumulated through electronic purchases (DCs or credit cards) which are redeemable when making a payment to a merchant selling the coupon bearing merchandise.

A customer may replenish their gift cards via an online DC to gift card transfer. This is similar to DC to ACH, DC to Wire, etc, transfer, in this case the value gets stored in an account accessed by a piece of plastic (e.g. Stored Value card) that is physically kept with the user or alternatively the value may be assigned to a specific merchant gift card. Either method allows the card to be used in stores by enabling the ECS to generate a non-changeable IRD made payable to the merchant (this ties to DC device and DC control features). This allows a user to easily take a DC to the merchants to buy items while not having to pre-fill out a check. Using the ECS UI methods, a user types in their specific gift card or stored value card identification code, and the ECS transfers funds by linking the DC to the internal store system (via EPCH) to replenish value onto the card. Additionally, the ECS allows the user to link the gift card with their DC device, thus a customer does not need to carry the card. Online replenishment saves time and is convenient, allows a DC to be used in the store instead of relying on checks written at POS checkout or 3^{rd} party endorsements or cashing a check at a store. Safety and security are also enhanced, as there is no need to carry a blank check/card with you to the store, a DC is already tied to the plastic card/DC device when you get to the store to shop. Another use of this feature is to move a DC onto a credit card to store the value onto an existing credit card balance.

The ECS may further provide a universal coupon card with a UPC barcode on a check card/device. Here, the ECS issues a secure plastic card/device with a UPC code that identifies the user, also contains stored value, clears like a coupon, and deducts the amount from your bill. A business may issue the cards/devices to preferred customers as rewards or they may give them away as gift cards/devices (e.g., similar to Amex or Visa gift cards etc), they clear as coupons not as credit cards. This implementation has no verification, the card/device is secure to prevent fraud, and is kept by the merchant, batched up and sent back to GSF for reloading and reissuing. Also, this may be accepted places that a UPC barcode may be scanned and deducted like a coupon.

Although the instant disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the instant disclosure and are intended to be covered by the following claims.

1. An electronic coin system comprising:
a point of sale (POS) device that sends a chance input;
the electronic coin system creates a digital coin check to provide change payment of coins, tracks activity of the digital coin check and allows access to the digital coin check;
a memory that stores, in a digital coin payment file the digital coin check as metadata defining a negotiable instrument, wherein the metadata comprises a coin payment instruction, a globally unique identifier, tracking information and security information, wherein the metadata in the digital coin payment file is interoperable with coin/paper and electronic clearing methods associated with coin/check clearing system and wherein the electronic coin system and the memory are communicably coupled; and
a portable digital to machine (D2M) device that is notified of and allows access to created digital coin check.

2. The electronic coin system of claim 1 further comprising a biometric interface that connects a user to the electronic coin system.

3. The electronic coin system of claim 2 further comprising a mobile application on the portable D2M device that allows one user of said application to deposit/withdraw cash from another nearby user of said application.

4. The electronic coin system of claim 1 wherein the digital coin check comprises a legal coin check item created and maintained electronically from creation to clearing in the electronic coin system.

5. The electronic coin system of claim 4 further comprises an application module that converts the digital coin check to a food stamp and clears said food stamp via a traditional food stamp system for reimbursement by a federal, state, or local governmental health and human services department.

6. The electronic coin system of claim 3 further comprises an application module that allows a parent user to set up an account for digital coin checks, link with a child's device to setup a period of fund transfer to support a child's daily expense, and provide reports of the child's spending activities.

7. The electronic coin system of claim 1 wherein notification of the portable D2M device is performed after the digital coin check is created and stored that the digital coin check is available in the memory of the electronic coin system.

8. The electronic coin system of claim 1 wherein the portable D2M accesses the digital coin check through the electronic coin system.

9. The electronic coin system of claim 1 wherein the digital coin check is created by the POS device.

10. (canceled)

11. (canceled)

12. The electronic coin system of claim 1 further comprising accepting by the POS device and the portable D2M device a fill set of warranties and indemnities applicable to banks and clearing banks thereby enabling electronic presentment from the POS device to the portable D2M device of the digital coin check under a Uniform Commercial Code and extending existing coin check clearing regulations between POS device and the portable D2M device and through associated banks and clearing banks.

13. The electronic coin system of claim 1 further comprising, setting of a time-to-live value associated with the digital coin check, wherein upon expiry of the time-to-live value, the digital coin check is no longer valid.

14. The electronic coin system of claim 1 further comprising, providing a transaction risk placement upon creating the digital coin check.

15. An electronic coin payment method, comprising:
receiving, by a point of sale (POS) device, from a sender device a payment to at least one receiver device;
creating, by an electronic coin system, a digital coin check to provide change payment of coins, responsive to the sender device;
storing, in at least one memory, the digital coin check as metadata defining a negotiable instrument in a digital coin file, wherein the metadata comprises a coin payment instruction, a globally unique identifier, tracking, information and security information, wherein the metadata in the digital coin payment file is interoperable with coin/paper and electronic clearing methods associated with coin/check clearing system and wherein the at least one processor and the at least one memory are communicably coupled;
notifying, a portable digital to machine (D2M) device, the at least one POS device of the digital coin check;
tracking, by the electronic coin system, activity of the digital coin check;
providing access, by the electronic coin system, of the at least one receiver device to the digital coin check; and
processing the digital coin check by the at least one POS device.

16. The electronic coin payment method of claim 15, wherein the access comprises one of a web user interface, a digital coin check device, and a software program configured to provide at least one of an OFX file, an XML file, and an Application Programming Interface.

17. The electronic coin payment method of claim 16, wherein the OFX and XML file are created directly through the software program, and wherein the software program includes a plugin configured to generate the digital coin check using OFX and XML file.

18. The electronic coin payment method of claim 15, wherein the digital coin check is processed through one of forwarding the metadata to bank as an electronic Cash Letter File, printing a substitute check from the metadata, forwarding the metadata as another digital coin check to a third party, and one of converting and truncating the digital coin check to an Automated Clearing House item.

19. The electronic coin payment method of claim 15, wherein the digital coin check is created as a coupon.

20. The electronic coin payment method of claim 15, further comprising receiving, by the electronic coin system, statistics associated with the tracking of the digital coin check.

21. The electronic coin payment method of claim 15, further comprising providing, by the electronic coin system, a payment score from statistics, wherein the payment score comprises a rating for a sender associated with the digital coin check.

22. The electronic coin payment method of claim 15, further comprising authenticating, by the electronic coin system, the digital coin check with a public key cryptography system.

23. An electronic coin system comprising at least one processor that:
confirms, by the electronic coin system, acceptance of a contract by a first user device;
generates, by the electronic coin system, a digital coin check to provide change payment of coins, as metadata defining a negotiable instrument in an electronic coin payment file, wherein the metadata comprises a coin payment instruction, a globally unique identifier, tracking information and security information, wherein the metadata in the digital coin payment file is interoperable with coin/paper and electronic clearing methods associated with coin/check clearing system and;
transmits, by the electronic coin system, an availability of the digital coin check to a second user device; and
processes, by the electronic coin system, the electronic coin payment file to provide at least one payment coin to the second user device.
